(19) United States
(12) Patent Application Publication
(10) Pub. No.: US 2016/0070126 A1
(43) Pub. Date: Mar. 10, 2016

(54) ELECTRO-OPTICAL DEVICE, AND ELECTRONIC APPARATUS

(71) Applicant: SEIKO EPSON CORPORATION, Tokyo (JP)

(72) Inventors: Junichi WAKABAYASHI, Matsumoto-shi (JP); Takashi TOYOOKA, Matsumoto-shi (JP); Taku KITAGAWA, Shiojiri-shi (JP)

(21) Appl. No.: 14/784,571

(22) PCT Filed: Apr. 11, 2014
(86) PCT No.: PCT/JP2014/002090

§ 371 Date: Oct. 14, 2015

(30) Foreign Application Priority Data
Apr. 15, 2013 (JP) 2013-084616

(51) Int. Cl. G02F 1/1335; G09G 3/20; G09G 3/36; G09G 3/34

(52) U.S. Cl. CPC G02F 1/1336; G02F 1/133514; G09G 3/3413; G09G 3/2018; G09G 3/3688; G02F 2001/133601; G09G 2310/027; G09G 2320/0252; G09G 2320/029; G09G 2320/0626

(57) ABSTRACT

A display device includes a liquid crystal element in which a transmissivity is controlled according to a data signal, and which extends in a first direction, a data line, a data line driving circuit that supplies a data signal to the liquid crystal element via the data line, and a light source that irradiates the liquid crystal element with the light, in which the light source moves the irradiation position of the light in the liquid crystal element in a first direction in a part of or the entire display period, and the data line driving circuit supplies the data signal in which the transmissivity of the liquid crystal element becomes a transmissivity that corresponds to the gradation to be displayed at the irradiation position of the light with which the liquid crystal element is irradiated to the liquid crystal element.

### TECHNICAL FIELD

The present invention relates to an electro-optical device and an electronic apparatus.

### BACKGROUND ART

A liquid crystal display device is known as an example of an electro-optical device provided with an electro-optical element for which the optical characteristics vary according to electrical energy. The liquid crystal display device is provided with a plurality of data lines and a plurality of scanning lines, and a pixel circuit is provided corresponding to the intersection of a data line with a scanning line. The pixel circuit includes a selection transistor and a liquid crystal element which is an electro-optical element. The selection transistor is controlled for an on state and an off state according to a scanning signal supplied via the scanning line. When the selection transistor is in the on state, a data signal supplied via the data line is applied to the liquid crystal element (for example, PTL 1).

In this case, the pixels, which are the smallest unit of the display, have a one-to-one correspondence with the pixel circuits provided in the liquid crystal display device.

### CITATION LIST

### Patent Literature

PTL 1: Japanese Unexamined Patent Application Publication No. 2011-186450

### SUMMARY OF INVENTION

### Technical Problem

Incidentally, numerous needs, such as size decreases or higher definition in the liquid crystal display device, have arisen in recent years. However, in cases where the size of the liquid crystal display is decreased or the pitch of the pixels is narrowed in order to address these needs, a highly dense arrangement of pixel circuits is necessary. Therefore, there is demand for highly technical manufacturing in the manufacturing of the liquid crystal display device that accompanies size decreases in the liquid crystal display or the narrowing of pixel pitch, and the costs increase.

The invention has been conceived in consideration of the above-described situation, and an object is to narrow the pitch of pixels while restricting manufacturing costs.

### Solution to Problem

In order to solve the problem described above, according to an aspect of the invention, there is provided an electro-optical device including: an electro-optical element in which transmissivity is controlled by a data signal, and which extends in a first direction; a data line; a supply portion that supplies the data signal to the electro-optical element via the data line; and a light source that irradiates the electro-optical element with light. The light source moves an irradiation position of the light in the electro-optical element in the first direction in a part of or the entire display period, and the supply portion supplies a data signal in which the transmissivity of the electro-optical element becomes a transmissivity corresponding to a gradation to be displayed at the irradiation position of the light with which the electro-optical element is irradiated to the electro-optical element when the light source irradiates the electro-optical element with the light.

According to the invention, because the light source moves the irradiation position of light, and the supply portion supplies the data signal that regulates the gradation to be displayed at the irradiation position of light to the electro-optical element, different gradations can be displayed at each position in the electro-optical element. That is, according to the invention, the pixel that is the smallest unit of the display is determined by the irradiation position of light from the light source. Therefore, because a plurality of pixels can be provided corresponding to one electro-optical element, the pitch of the pixels can be narrowed without highly densely arranging the electro-optical elements, and as a result, a high resolution display can be arranged at a low cost.

According to the invention, a part from the electro-optical element irradiated with light of the light source becomes a part that contributes to display. That is, the electro-optical device in the invention selects the pixel that contributes to display by radiating light at a given time. Therefore, the electro-optical device according to the invention eliminates the need to provide a data line for selecting the pixel as in the related art, and further eliminates the need to provide pixel circuits including a selection transistor or the like in which the on and off states are controlled by a signal supplied from the scanning line in a one-to-one correspondence with the pixels as in the related art (that is, the need to provide the pixel circuits is eliminated). That is, according to the invention, the structure of the electro-optical device can be simplified, and the manufacturing costs of the electro-optical device can be reduced.

In the invention, the “electro-optical element”, for example, may be a liquid crystal element.

The “electro-optical element extending in the first direction” may signify the width in the first direction of the electro-optical element being wider than the width in the second direction that intersects the first direction.

In the electro-optical device, preferably, the display period includes a first period, a second period that follows the first period, and a third period that follows the second period, and the light source is able to irradiate the electro-optical element with three colors of light including a first light having a first color, a second light having a second color, and a third light having a third color, irradiates the electro-optical element with the first light and moves an irradiation position of the first light in the electro-optical element in the first direction from the first irradiation position in the first period, irradiates the electro-optical element with the second light and moves an irradiation position of the second light in the electro-optical element in the first direction from the first irradiation position in the second period, and irradiates the electro-optical element with the third light and moves an irradiation position of the third light in the electro-optical element in the first direction from the first irradiation position in the third period.

According to the aspect, the electro-optical element displays the first color in the first period, displays the second color in the second period, and displays the third color in the third period. Therefore, because the three colors can be displayed with one electro-optical element, the structure of the electro-optical device can be simplified, reduced in size, and an increase in definition is possible compared to a case of providing three (three types) electro-optical elements corresponding to each of the three colors.

According to another aspect of the invention, there is provided an electro-optical device including: a plurality of electro-optical elements in which the transmissivity is controlled according to a data signal; a plurality of data lines; a supply portion that supplies the data signal to each of the plurality of electro-optical elements via the plurality of data lines; and a light source that irradiates the plurality of electro-optical elements with light. Each of the plurality of electro-optical elements is provided so as to extend in a first direction, the plurality of electro-optical elements is provided so as to be lined up in one column in a second direction that intersects the first direction, the light source moves an irradiation position of the light on the plurality of electro-optical elements in the first direction in a part of or the entire display period, and the supply portion supplies a data signal in which the transmissivity of one of the electro-optical elements irradiated with the light becomes the transmissivity corresponding to the gradation to be displayed at the irradiation position of the light with which the one electro-optical element is irradiated to the one electro-optical element when the light source irradiates the plurality of electro-optical elements with the light.

In the electro-optical device, preferably, the light radiated by the light source is linear light having a spread in the second direction.

According to the aspect, because the plurality of electro-optical elements can be irradiated at the same time with one linear light, the structure of the light source and control of the irradiation position of light from the light source becomes easy compared to a case of irradiating each electro-optical element with a separate light, and the manufacturing costs of the electro-optical device can be suppressed to be low.

In the electro-optical device, preferably, the display period is formed from a plurality of unit periods, and the light source moves the irradiation position of the light on the plurality of electro-optical elements from a first irradiation position in the second direction in one unit period, and moves the irradiation position from a second irradiation position that is a position moved by a predetermined distance further in the first direction than the first irradiation position in the second direction in another unit period that follows the one unit period.

In the electro-optical element, preferably, the display period includes a first period, a second period that follows the first period, and a third period that follows the second period, and the light source is able to irradiate the plurality of electro-optical elements with three colors of light including a first light having a first color, a second light having a second color, and a third light having a third color, and irradiates the plurality of electro-optical elements with the first light in the first period, irradiates the plurality of electro-optical elements with the second light in the second period, and irradiates the plurality of electro-optical elements with the third light in the third period.

The electro-optical device preferably further includes a plurality of color filters that includes a first color filter for transmitting first light having a first color, a second color filter for transmitting second light having a second color, and a third color filter for transmitting third light having a third color. Preferably, the light source is able to irradiate the plurality of electro-optical elements with a predetermined color of light that includes a component of the first light, a component of the second light and a component of the third light, and the plurality of electro-optical elements includes a first electro-optical element provided corresponding to the first color filter, a second electro-optical element provided corresponding to the second color filter, and a third electro-optical element provided corresponding to the third color filter.

According to the aspect, the second electro-optical element may be adjacent to the first electro-optical element in the second direction, and the third electro-optical element may be adjacent to the second electro-optical element in the second direction.

According to still another aspect of the invention, there is provided an electro-optical device including: a plurality of electro-optical elements in which the transmissivity is controlled according to a data signal; a plurality of data lines; a supply portion that supplies the data signal to each of the plurality of electro-optical elements via the plurality of data lines; and a light source that irradiates the plurality of electro-optical elements with a predetermined number of lights. Each of the plurality of electro-optical elements is provided so as to extend in a first direction, the plurality of electro-optical elements includes a block formed from the predetermined number of electro-optical elements lined up in one row in the first direction, the light source irradiates each of the predetermined number of electro-optical elements included in the block with the predetermined number of lights, and moves the irradiation position of each of the predetermined number of lights on the plurality of electro-optical elements in the first direction in a part of or the entire display period, and the supply portion supplies a data signal in which the transmissivity of one of the electro-optical elements irradiated with one light of the predetermined number of lights becomes the transmissivity corresponding to the gradation to be displayed at the irradiation position of the one light with which the one electro-optical element is irradiated to the one electro-optical element when the light source irradiates the plurality of electro-optical elements with the predetermined number of lights.

In the electro-optical device, preferably, each of the predetermined number of lights irradiated by the light source is linear light having a spread in a second direction that intersects the first direction, the plurality of electro-optical elements includes a plurality of the blocks, and the plurality of blocks is provided so as to be lined up in one column in the second direction.

In the electro-optical device, preferably, the plurality of electro-optical elements includes a plurality of the blocks, the plurality of blocks is provided so as to be lined up in one column in a second direction that intersects the first direction, the display period is formed from a plurality of unit periods, and the light source moves the irradiation position of each of the predetermined number of lights on the plurality of electro-optical elements in the second direction in one unit period, and moves the irradiation position in the second direction to a position moved by a predetermined distance further in the first direction than the irradiation position in the first unit period in another unit period following the one unit period.

In the electro-optical device, preferably, the display includes a first period, a second period that follows the first period, and a third period that follows the second period, the block includes a first electro-optical element, a second electro-optical element adjacent to the first electro-optical element in the first direction, and a third electro-optical element adjacent to the second electro-optical element in the first direction, and the light source is able to irradiate the plurality of electro-optical elements with three colors of light including a first light having a first color, a second light having a second color, and a third light having a third color, the first electro-optical element is irradiated with the first light, the second electro-optical element is irradiated with the second light, and the third electro-optical element is irradiated with the third light in the first period, the second electro-optical element is irradiated with the first light, the third electro-optical element is irradiated with the second light, and the first electro-optical element is irradiated with the third light in the second period, and the third electro-optical element is irradiated with the first light, the first electro-optical element is irradiated with the second light, and the second electro-optical element is irradiated with the third light in the third period.

The electro-optical device preferably further includes a plurality of color filters that includes a first color filter for transmitting first light having a first color, a second color filter for transmitting second light having a second color, and a third color filter for transmitting third light having a third color. Preferably, the light source is able to irradiate the plurality of electro-optical elements with a predetermined number of lights having a predetermined color of light that includes a component of the first light, a component of second light and a component of third light, and the plurality of electro-optical elements includes a first electro-optical element provided corresponding to the first color filter, a second electro-optical element provided corresponding to the second color filter, and a third electro-optical element provided corresponding to the third color filter.

According to the aspect, the second electro-optical element may be adjacent to the first electro-optical element in the second direction that intersects the first direction, and the third electro-optical element may be adjacent to the second electro-optical element in the second direction.

According to still another aspect of the invention, there is provided an electronic apparatus including the electro-optical device including any one of the display control circuits above or any one of the electro-optical devices above. A car navigation device, personal computer, television, projection-type display device, mobile phone or the like come under such an electronic apparatus.

### BRIEF DESCRIPTION OF DRAWINGS

FIG. 1 is a block diagram showing an electro-optical device according to a first embodiment of the invention.

FIG. 2 is an explanatory diagram for describing an irradiation position of light radiated from a light source.

FIG. 3 is a timing chart for illustrating the operation of the electro-optical device.

FIG. 4 is an explanatory diagram for describing the irradiation position of light radiated from the light source.

FIG. 5 is a timing chart for illustrating the operation of the electro-optical device.

FIG. 6 is an explanatory diagram for describing the irradiation position of light radiated from the light source according to a second embodiment of the invention.

FIG. 7 is a timing chart for illustrating the operation of the electro-optical device.

FIG. 8 is an explanatory diagram for describing the irradiation position of light radiated from the light source.

FIG. 9 is a timing chart for illustrating the operation of the electro-optical device.

FIG. 10 is a block diagram of an electro-optical device according to a third embodiment of the invention.

FIG. 11 is a timing chart for illustrating the operation of the electro-optical device.

FIG. 12 is a block diagram of an electro-optical device according to a fourth embodiment of the invention.

FIG. 13 is an explanatory diagram for describing the irradiation position of light radiated from the light source.

FIG. 14 is a timing chart for illustrating the operation of the electro-optical device.

FIG. 15 is a perspective diagram of an electronic apparatus (projection-type display device).

FIG. 16 is a perspective diagram of an electronic apparatus (personal computer).

FIG. 17 is a perspective view of an electronic apparatus (mobile phone).

### DESCRIPTION OF EMBODIMENTS

Below, embodiments of the invention will be described with reference to the drawings. However, the dimensions and scale of each portion in each drawing are made different from the actual ones, as appropriate. Since the embodiments described below are preferred specified examples of the invention, various preferred technical limits are applied; however, the scope of the invention is not limited to these embodiments unless a limitation on the invention is specifically disclosed in the following description.

### <A. First Embodiment>

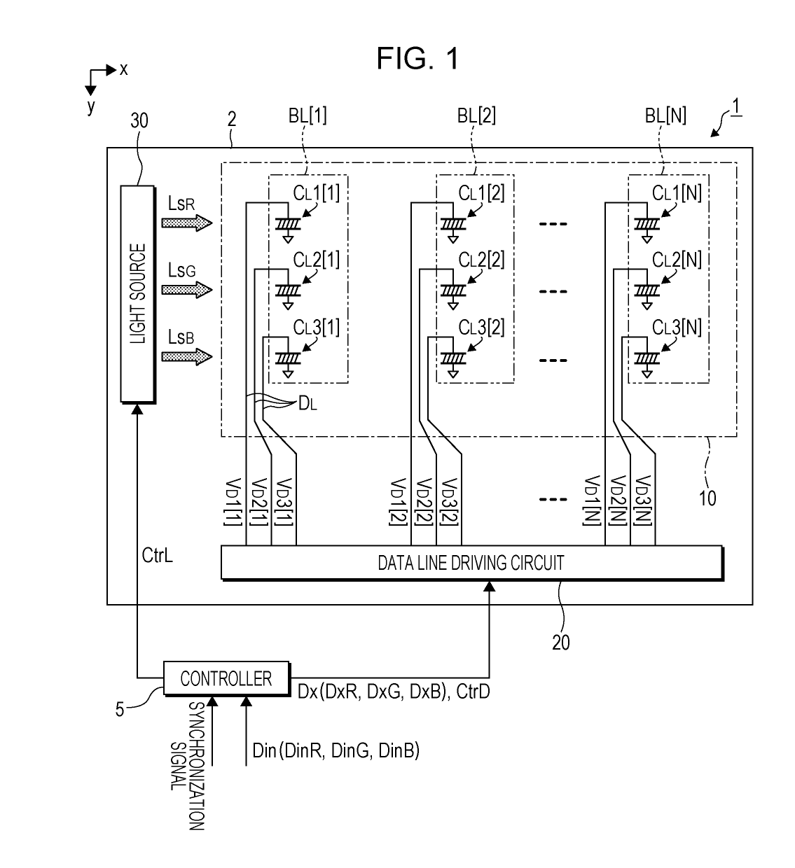

FIG. 1 is a block diagram of display device 1 (example of “electro-optical device”) according to a first embodiment. The display device 1 includes a display panel 2 and a controller 5.

Input image data Din is supplied from a parent device, not shown, to the controller 5 in synchronization with a synchronization signal.

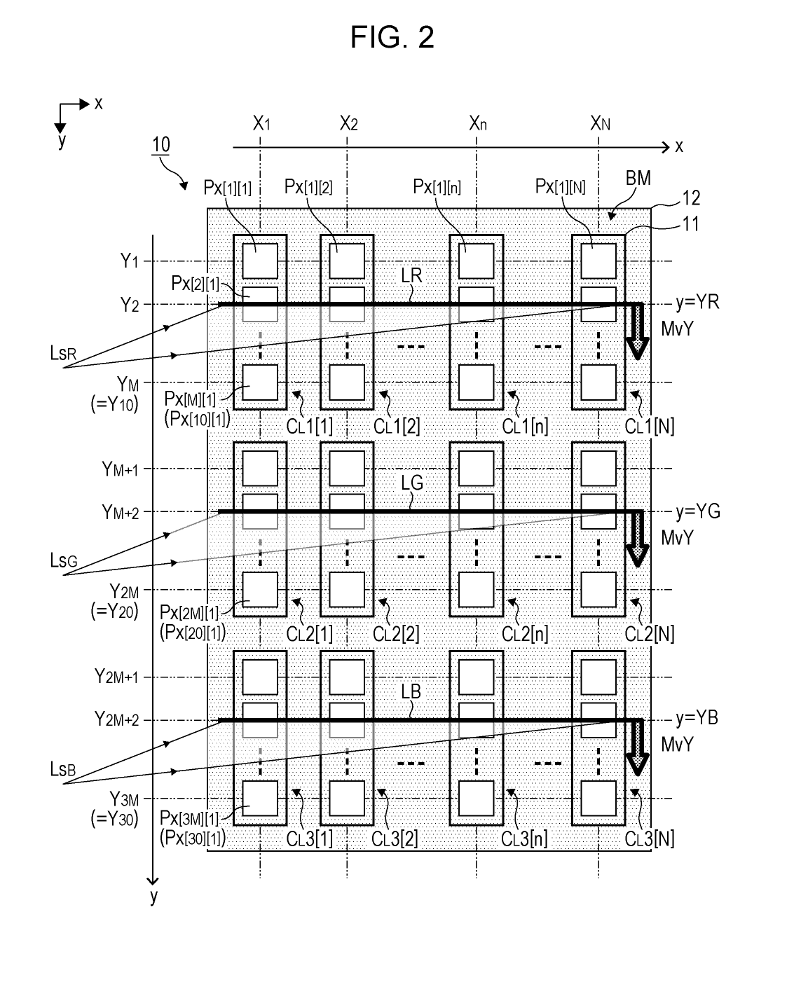

The input image data Din is data that stipulates the gradation to be displayed with each of a plurality of pixels Px (pixels Px are described in detail in FIG. 2) provided in the display panel 2. The input image data Din may be, for example, digital data that stipulates the gradation to be displayed with each pixel Px with 8 bits.

In the embodiment, each of the plurality of pixels Px provided in the display panel 2 displays red R (example of “first color”), green G (example of “second color”), and blue B (example of “third color”). The input image data Din includes input image data DinR that stipulates the gradation to be displayed by the pixel Px in a case where the pixel Px displays red R, input image data DinG that stipulates the gradation to be displayed by the pixel Px in a case where the pixel Px displays green G, and input image data DinB that stipulates the gradation to be displayed by the pixel Px in a case where the pixel Px displays blue B.

The synchronization signal is, for example, a signal that includes a vertical synchronization signal Vsnc, a horizontal synchronization signal Hsnc, and a dot clock signal Dclk.

The controller 5 generates a light source control signal CtrL that controls the light source 30, described later, and a driving control signal CtrD that controls a data line driving circuit 20, described later, based on a synchronization signal supplied from a parent device and supplies the signals to the display panel 2. The drive control signal CtrD and the light source control signal CtrL include a vertical synchronization signal Vsnc, a horizontal synchronization signal Hsnc, and a dot clock signal Dclk.

The controller 5 generates digital image data Dx by subjecting the input image data Din supplied from the parent device to gamma correction, and supplies the data to the display panel 2 in synchronization to the drive control signal CtrD. The image data Dx includes image data DxR that corresponds to the input image data DinR, image data DxG that corresponds to the input image data DinG, and image data DxB that corresponds to the input image data DinB.

The image data Dx may be an analog signal. In this case, the controller 5 provided with a DA conversion circuit is usable.

The display panel 2 is provided with a display portion 10 in which a plurality of liquid crystal elements CL (example of “electro-optical element”) is provided, a light source 30 that irradiates the display portion 10 with light Ls, a plurality of data lines DL provided corresponding to each of the plurality of liquid crystal elements CL, and a data line driving circuit 20 that supplies the data signal VD that stipulates the transmissivity of each of the plurality of liquid crystal elements CL to the liquid crystal element CL via the data line DL.

The display portion 10 is provided with “3×N” liquid crystal elements CL in three vertical columns×N horizontal rows (N is a natural number that satisfies 1≦N). In other words, the display portion 10 is provided with 3 columns of liquid crystal elements CL in the y axis direction (example of a “first direction”), and N rows of liquid crystal elements CL in the x axis direction (example of a “second direction”) in FIG. 1.

Below, the liquid crystal element CL positioned at the nth row (n is a natural number that satisfies 1≦n≦N) of the kth column (k is a natural number that satisfies 1≦k≦3) is referred to as CLk[n]. Specifically, the liquid crystal element CL position at the nth row of the first column is referred to as CL1[n], the liquid crystal element CL positioned as the nth row of the second column is referred to as CL2[n], and the liquid crystal element CL positioned as the nth row of the third column is referred to as CL3[n].

The three liquid crystal elements CL positioned on each row are referred to as a block BL[n]. Specifically, the block BL[n] is configured by three liquid crystal elements CL formed from the liquid crystal element CL1[n], liquid crystal element CL2[n], and the liquid crystal element CL3[n].

The data line driving circuit 20 is provided with a DA conversion circuit, and generates an analog data signal VD based on the digital image data Dx supplied from the controller 5. The data line driving circuit 20 supplies the data signal VD to the liquid crystal element CL via the data line DL. The transmissivity of the liquid crystal element CL is determined according to the data line signal VD.

Below, the data line DL provided corresponding to the liquid crystal element CLk[n] is referred to as the data line DLk[n], and the data signal VD supplied to the liquid crystal element CLk[n] vial the data line DLk[n] is referred to as the data signal VDk[n]. That is, the data signal VDk[n] that corresponds to the liquid crystal element is supplied to the liquid crystal element CLk[n] via the data line DLk[n] that corresponds to the liquid crystal element. The transmissivity of the liquid crystal element CLk[n] is set according to a value indicated by the data signal VDk[n] when the data signal VDk[n] is supplied.

The data line driving circuit 20 controls the timing at which the data signal VDk[n] is supplied to each liquid crystal element CLk[n] based on the driving control signal CtrD.

The light source 30 irradiates the display portion 10 with three lights Ls at the same time. More specifically, the light source 30 irradiates the display portion 10 with the three lights Ls including the red light LsR (example of “first light”), the green light LsG (example of “second light”), and the blue light LsB (example of third light”).

The light source 30 controls irradiation position of each of the three lights Ls (LsR, LsG, LsB) and the timing of irradiation based on the light source control signal CtrL.

The relationship between the irradiation positions of the three lights Ls, and the arrangement positions of the liquid crystal elements CL and the pixels Px in the display portion 10 will be described with reference to FIG. 2.

As shown in FIG. 2, the display portion 10 is provided with one common electrode 12, “3×N” pixel electrodes 11 corresponding respectively to the “3×N” liquid crystal elements CL, and a liquid crystal (not shown) arranged between each pixel electrode 11 and the common electrode 12. The liquid crystal element CL is configured to include a pixel electrode 11, the common electrode 12, and a liquid crystal arranged between both electrodes.

As shown in FIG. 2, each liquid crystal element CL (pixel electrode 11) is provided so as to extend in the first direction, that is, the y axis direction, and has a shape that is vertically long in the y axis direction. That is, the width in the y axis direction of each liquid crystal element CL is wider than the width in the x axis direction.

A black matrix BM (hatched part in FIG. 2) is provided in the display portion 10, and the display portion 10 is divided into a plurality of pixels Px by the black matrix BM.

More specifically, the black matrix BM divides the display portion 10 (M is a natural number that satisfies 1≦M) so that M pixels Px are arranged in one row in the y axis direction in a region in which one liquid crystal element CL is provided. That is, “3×N” pixels Px in 3M vertical columns×N horizontal rows are arranged in the display portion 10, and three liquid crystal elements CL and “3×M” pixels Px are provided in each row.

In the embodiment, the black matrix BM, common electrode 12, liquid crystal, and pixel electrode 11 are provided, in order from the surface side, in the display portion 10, and, further, the light Ls is radiated from the surface side further than the pixel electrode 11.

However, this arrangement order is merely one example, and arranging may be performed in any order as long as the light Ls radiated from the light source 30 is able to pass through the liquid crystal and reach the observer side of the display portion 10.

The wording “surface side” is the observation surface side of the display portion 10 and the rear side of the paper falls within the surface side in FIG. 2. Conversely, the wording “rear surface side” is the opposite side to the observation surface side of the display portion 10, and the surface side of the paper falls within the rear surface side in FIG. 2.

Although the display portion 10 in the embodiment is provided with a black matrix BM, the black matrix BM may also not be provided. Even in this case, the pixels Px are defined by the positions in the display portion 10.

Below, as shown in FIG. 2, the pixel Px positioned at the mth column and the nth row of the “3M×N” pixels Px of the 3M vertical columns×N horizontal rows is denoted as pixel Px[m][n] (m is a natural number that satisfies 1≦m≦3M). In other words, M pixels Px[(k−1)*M+1][n] to pixels Px[kM][n] arranged in one row in the y axis direction are provided corresponding to one liquid crystal element CLk[n]. In other words, the M pixels Px[(k−1)*M+1][n] to pixels Px[kM][n] are provided common to one liquid crystal element CLk[n].

The position in the x axis direction of the pixel [m][n] in the display portion 10 is indicated as the position Xₙ, and the position in the y direction as the position Yₘ. That is, the positions of the pixels Px of the first to Nth rows are the positions X₁ to X_{N} respectively, and the positions of the pixel Px of the first to 3Mth columns are the positions Y₁ to Y_{3M} respectively.

The light source 30 irradiates the display portion 10 with red light LsR, green light LsG, and blue light LsB. The light Ls radiated by the light source 30 is “linear” light having a spread in the second direction, that is, the x axis direction, and the irradiation position of the light Ls on the display portion 10 becomes a line segment parallel to the x axis.

Below, the line segment indicating the irradiation position of the red light LsR in the display portion 10 is referred to as line segment LR, the line segment indicating the irradiation position of the green light LsG is referred to as line segment LG, and the line segment indicating the irradiation position of the blue light LsB is referred to as the line segment LB. The positions in the y axis direction of the line segments LR, LG, and LB are referred to as the irradiation positions YR, YG, and YB, respectively. As shown in FIG. 2, the line segments LR, LG, and LB are at least line segments including the range X₁≦x≦X_{N} in the x axis direction.

The light source 30 irradiates liquid crystal elements CL that are different from one another with the red light LsR, green light LsG, and the blue light LsB, respectively, and moves the irradiation position of the three light Ls in the y axis direction as indicated by the reference symbol “MvY” in FIG. 2.

In FIG. 2, a case where the line segment LR that indicates the irradiation position YR of the red light LsR is positioned at straight line y=Y₂ on the pixel Px[2][n] in the second column of the liquid crystal elements CL1[n] in the first row (that is, irradiation position YR=Y₂), the line segment LG that indicates the irradiation position YG of the green light LsG is positioned at straight line y=Y_{M+2} on the pixel Px[M+2][n] in the (M+2) column of the liquid crystal elements CL2[n] in the second row (that is, irradiation position YG=Y_{M+2}), and the line segment LB that indicates the irradiation position YB of the blue light LsB is positioned at straight line y=Y_{2M+2} on the pixel Px[2M+2][n] in the (2M+2) column of the liquid crystal elements CL3[n] in the third row (that is, irradiation position YB=Y_{2M+2}) is given as an example.

In the drawing shown below, a case where “M=10” is given as an example for simplicity. That is, a case where the pixels Px[1][n] to Px[10][n] are provided corresponding to the liquid crystal element CL1[n], the pixels Px[11][n] to Px[20][n] are provided corresponding to the liquid crystal element CL2[n], the pixels Px[21][n] to Px[30][n] are provided corresponding to the liquid crystal element CL3[n] is given as an example.

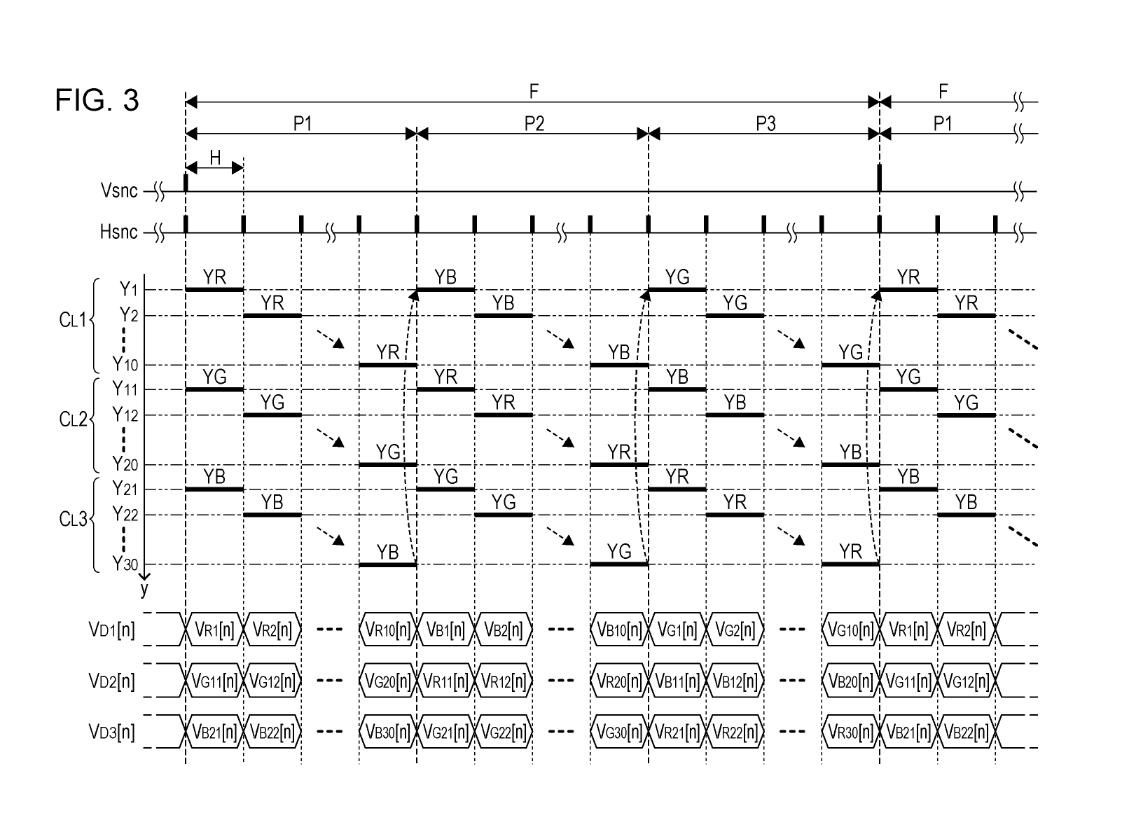

FIG. 3 is a timing chart showing an operation of the display device 1.

As shown in the drawing, the operation period of the display device 1 is formed from a plurality of display periods F. Each display period F includes (3M) unit periods H.

The display period F is divided into 3 control periods P having the same length of time as one another. More specifically, the period from the start time of the display period F until M unit periods H elapse is referred to as the control period P1, the period from the finish time of the control period P1 until M unit periods H elapse is referred to as the control period P2, and the period from the finish time of the control period P2 until M unit periods H elapse is referred to as the control period P3.

As described above, the driving control signal CtrD and the light source control signal CtrL supplied from the controller 5 include the vertical synchronization signal Vsnc and the horizontal synchronization signal Hsnc. As shown in FIG. 3, the vertical synchronization signal Vsnc is a signal that has a high level at the timing at which each display period F is started, and the horizontal synchronization signal Hsnc is a signal that has a high level at the timing at which each unit period H is started.

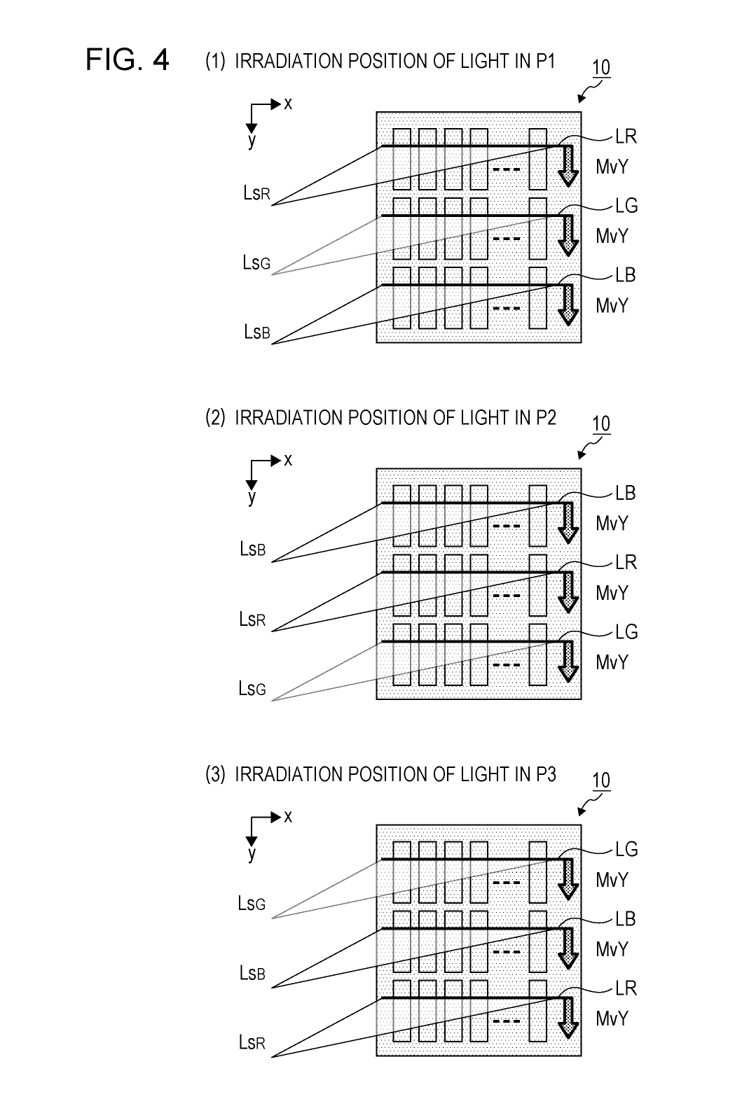

The light source 30 irradiates the irradiation position determined based on the vertical synchronization signal Vsnc and the horizontal synchronization signal Hsnc with three lights Ls (LsR, LsG, and LsB). Below, an example of the irradiation position of the three lights Ls radiated by the light source 30 will be described with reference to FIGS. 3 and 4 in addition to FIG. 2.

As shown in FIG. 3, in the embodiment, the light source 30 radiates the three lights Ls so that the irradiation positions of the three lights Ls (LsR, LsG, LsB) are held at a predetermined interval with one another and each irradiation position of the three lights Ls moves by one pixel in the (+y) direction for each unit period H in each control period P (P1, P2, and P3).

More specifically, the light source 30, as shown in FIGS. 3 and 4, irradiates the liquid crystal element CL1[n] with the red light LsR, irradiates the liquid crystal element CL2[n] with the green light LsG, and irradiates the liquid crystal element CL3[n] with the blue light LsB in the control period P1.

The light source 30 irradiates the liquid crystal element CL1[n] with the blue light LsB, irradiates the liquid crystal element CL2[n] with the red light LsR, and irradiates the liquid crystal element CL3[n] with the green light LsG in the control period P2.

The light source 30 irradiates the liquid crystal element CL1[n] with the green light LsG, irradiates the liquid crystal element CL2[n] with the blue light LsB, and irradiates the liquid crystal element CL3[n] with the red light LsR in the control period P3.

The light source 30 moves the respective irradiation positions (YR, YG, YB) of the three lights Ls by one pixel in the (+y) direction for each unit period H in each control period P.

For example, in the control period P1, the light source 30 radiates the red light LsR so that the irradiation position YR of the red light LsR becomes position Y₁ in the initial unit period H of the control period P1, and thereafter is moved by one pixel in the (+y) direction for each unit period H, and becomes the position Y₁₀ (Y_{M}) in the final unit period H of the control period P1.

Similarly, in the control period P1, the light source 30 radiates the green light LsG and the blue light LsB so that the irradiation position YG of the green light LsG moves from the position Y₁₁ (Y_{M+1}) to the position Y₂₀ (Y_{2M}), and the irradiation position YB of the blue light LsB moves from the position Y₂₁ (Y_{2M+1}) to the position Y₃₀ (Y_{3M}).

The light source 30 radiates the three lights Ls so that the irradiation position YR of the red light LsR moves from the position Y₁₁ to the position Y₂₀, the irradiation position YG of the green light LsG moves from the position Y₂₁ to the position Y₃₀, and the irradiation position YB of the blue light LsB moves from the position Y₁ to the position Y₁₀ in the control period P2, and radiates the three lights Ls so that the irradiation position YR of the red light LsR moves from the position Y₂₁ to the position Y₃₀, the irradiation position YG of the green light LsG moves from the position Y₁ to the position Y₁₀, and the irradiation position YB of the blue light LsB moves from the position Y₁₁ to the position Y₂₀ in the control period P3.

In this way, the light source 30 moves the irradiation position of each light Ls from a given position Yₘ by one pixel at a time in the (+y) direction for each unit period H. The light source 30 moves the irradiation position of the light Ls to the position Y₁ in the next unit period H in a case where the irradiation position of the light Ls reaches the position Y_{3M} in a given unit period H, and thereafter further moves the irradiation position of the light Ls by one pixel at a time in the (+y) direction for each unit period.

The data line driving circuit 20 supplies the data signal VD that stipulates the gradation to be displayed by the pixel Px irradiated by the light Ls when the pixel Px is irradiated with the light Ls, to the liquid crystal element CL corresponding to the pixel Px irradiated by the light Ls.

Specifically, the data line driving circuit 20 supplies the data signal VRm[n] that stipulates the gradation when the pixel Px[m][n] displays red R to the liquid crystal element CLk[n] as the data signal VDk, in the unit period H in which the pixel Px [m][n] is irradiated with red light LsR in a case where the pixel Px[m][n] is provided corresponding to the liquid crystal element CLk[n] (that is, a case where the pixel [m][n] is provided with the liquid crystal element CLk[n]).

The data line driving circuit 20 supplies the data signal VGm[n] that stipulates the gradation when the pixel [m][n] displays green G to the liquid crystal element CLk[n] as the display signal VDk[n] in a unit period H in which the pixel Px[m][n] is irradiated with the green light LsG.

The data line driving circuit 20 supplies the data signal VBm[n] that stipulates the gradation when the pixel [m][n] displays blue B to the liquid crystal element CLk[n] as the display signal VDk[n] in a unit period H in which the pixel Px[m][n] is irradiated with the blue light LsB.

For example, as shown in FIG. 3, the data line driving circuit 20 supplies the data signal VR1[n] in which the gradation to be displayed by the pixel Px[1][n] is stipulated in a case where the pixel Px[1][n] displays red R, to the liquid crystal element CL1[n] corresponding to the pixel Px[1][n] (that is, the pixel Px positioned at the irradiation position YR) irradiated with the red light LsR in the initial unit period H of the control period P1.

Similarly, the data line driving circuit 20 supplies the data signal VR2[n] in which the gradation to be displayed by the pixel Px[2][n] is stipulated in a case where the pixel Px[2][n] displays red R, to the liquid crystal element CL1[n] corresponding to the pixel Px[2][n] irradiated with the red light LsR in the second unit period H of the control period P1.

In this way, in each unit period H, the transmissivity of the liquid crystal element CLk[n] is set corresponding to the gradation to be displayed by the pixel Px irradiated by the light Ls in each of the unit periods H of the M pixels Px provided corresponding to the liquid crystal element CLk[n].

The liquid crystal element CLk[n] is provided common to the M pixels Px. Therefore, in one unit period H, in a case where one pixel Px is irradiated with light Ls, the transmissivity of the liquid crystal element CL (liquid crystal element CLk[n]) that is the constituent element of (M−1) other pixels Px not irradiated with light Ls in the one unit period H, also becomes the transmissivity corresponding to the gradation to be displayed by one pixel Px.

However, other pixels Px other than the one pixel Px are not irradiated with the light Ls in the one unit period H. Thus, in the one unit period H, it is possible to prevent the other pixels Px from displaying different gradation from the gradation to be originally displayed. In other words, in each unit period H, only the pixel Px irradiated with the light Ls in the unit period H of the M pixels Px provided corresponding to the liquid crystal element CLk[n] contributes to display.

Each pixel Px is irradiated by the three lights Ls including red light LsR, green light LsG, and blue light LsB in each display period F. For example, as clarified in FIGS. 2 and 3, the pixel Px[1][n] is irradiated with red light LsR in the control period P1, irradiated with blue light LsB in the control period P2, and irradiated with green light LsG in the control period P3.

That is, each pixel Px of the display device 1 according to the embodiment displays the three colors of red R, green G, and blue B in each display period F.

As described above, in the embodiment, one liquid crystal element CL (one pixel electrode 11) is provided shared by M pixels Px. In other words, the display device 1 of the embodiment has a resolution of M times the number of liquid crystal elements CL provided in the display portion 10.

Therefore, compared to a case where a plurality of liquid crystal elements CL is provided so as to have a one-to-one correspondence with a plurality of pixels Px, it is possible to increase the size of each liquid crystal element CL (that is, reducing the size of the liquid crystal element CL becomes unnecessary), to simplify the structure of the display portion 10, and to suppress manufacturing costs of the display device 1 to be low.

In the related art, the display device provided with a liquid crystal element, for example, is provided with a plurality of scanning lines, a plurality of data lines, and a plurality of pixels provided corresponding to the intersections of the plurality of scanning lines and the plurality of data lines. Each pixel is provided with a liquid crystal element including a pixel electrode, a common electrode, and a liquid crystal provided between the pixel electrode and the common electrode, and a selection transistor provided between the data line and the pixel electrode, and controlled to be on or off by an operation signal supplied from the scanning line. The pixel is selected by supplying the scanning signal to the scanning line corresponding to the pixel, and turning the selection transistor on, and, along therewith, the gradation stipulated by the data signal is displayed by the pixel by supplying the data signal to the data line corresponding to the selected pixel.

However, in such a liquid crystal display device of the related art, it is necessary to provide a selection transistor and a pixel electrode for each pixel, and it is necessary to provide a scanning line for each column.

In contrast, the display device 1 according to the embodiment is provided with one liquid crystal element CL (one pixel electrode 11) shared by M pixels Px, and one data line is connected to the pixel electrode 11 of each liquid crystal element CL. The display device 1 according to the embodiment, by irradiating the pixel Px with the light Ls, displays the gradation (that is, the gradation stipulated by the input image data Din) stipulated by the data signal VD with the pixel Px irradiated with the light Ls. That is, the display device 1 according to the embodiment is not provided with a thin film transistor (TFT), such as a selection transistor, in the display portion 10 and a scanning line is also not provided.

Therefore, the display device 1 according to the embodiment is able to simplify the structure of the display portion 10, and to suppress the manufacturing costs of the display device 1, compared to the liquid crystal display device in the related art.

One pixel Px of the display device 1 according to the embodiment displays the three colors of red R, green G, and blue B in each display period F. Therefore, it is possible to achieve approximately triple the resolution and to increase the definition of the display compared to a case where three types of pixel Px are separately provided corresponding to each of the colors of red R, green g, and blue B.

In the embodiment, the irradiation position of the light Ls is moved by one pixel in the y axis direction for each unit period H by the light source 30 moving the irradiation position of the light Ls by one pixel in the y axis direction when the unit period H finishes (or when starting) in one unit period H without varying the position in the one unit period H; however, the invention is not limited to such an aspect.

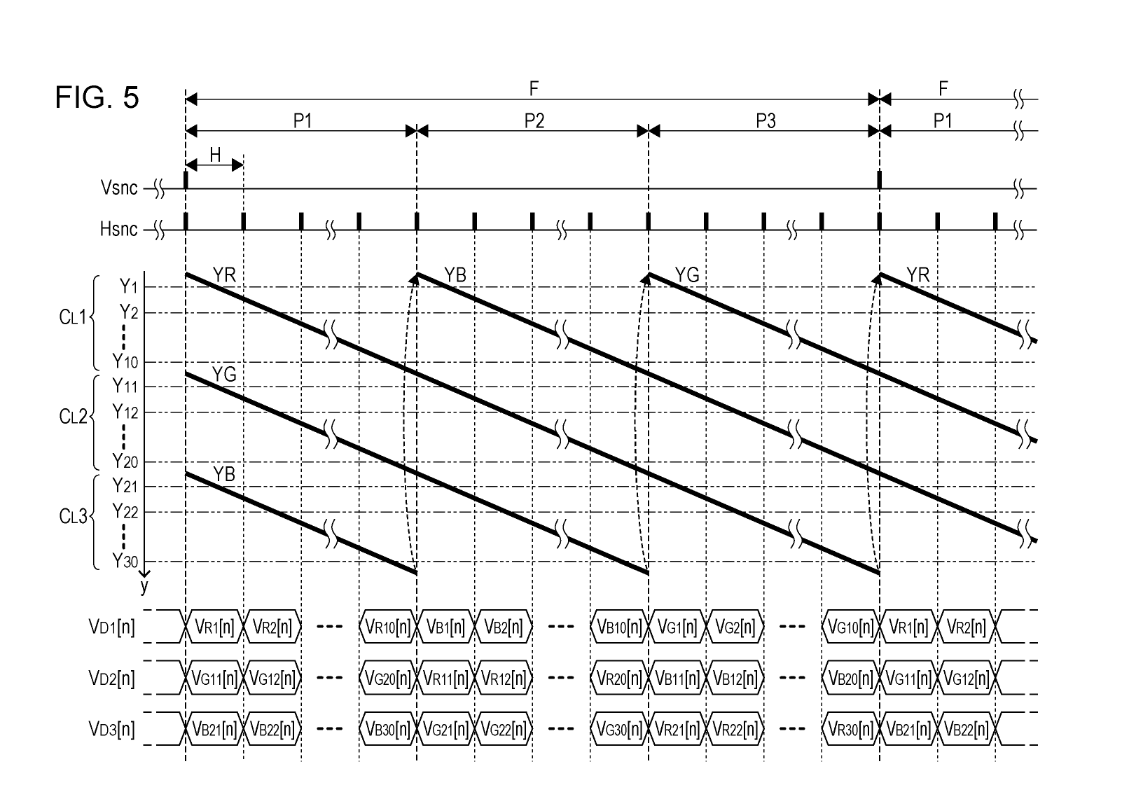

For example, the light source 30, as shown in FIG. 5, may continuously (for example, at a constant speed) move the irradiation position of light Ls.

In short, the light source 30 may radiate light Ls so that only the pixel Px that contributes to display is irradiated with the light Ls in each unit period H and the pixels Px that do not contribute to display in each unit period H are not irradiated with the light Ls.

That is, the light source 30 is usable as long as the light source radiates the three lights Ls so that the conditions (1) and (2) shown below are satisfied.

(1) One liquid crystal element CL is not irradiated with two or more lights Ls at the same time.
(2) In a case where one liquid crystal element CL is irradiated with one light Ls in one unit period H, only one pixel Px of the M pixels Px with which the one liquid crystal element CL is provided is irradiated with the light Ls in the one unit period H (that is, in the one unit period H, the remaining [M−1] liquid crystal elements CL with which the one liquid crystal element CL is provided are not irradiated with the one light Ls).

More preferably, the light source 30 may radiate the three lights Ls so that the condition (3) shown below is satisfied, in addition to the above-described conditions (1) and (2).

(3) In each display period F, all of the pixels Px corresponding to all of the liquid crystal elements CL are irradiated with each light Ls.

### <B. Second Embodiment>

In the first embodiment, the light Ls radiated by the light source 30 is “linear” light having a spread in the x axis direction, and the irradiation position of the light Ls on the display portion 10 is a line segment parallel to the x axis.

In contrast, the display device according to the second embodiment (example of an “electro-optical device”) differs from the display device 1 according to the first embodiment on the point of the light source radiating a “point-like” light not having a spread in both of the x axis direction and the y axis direction.

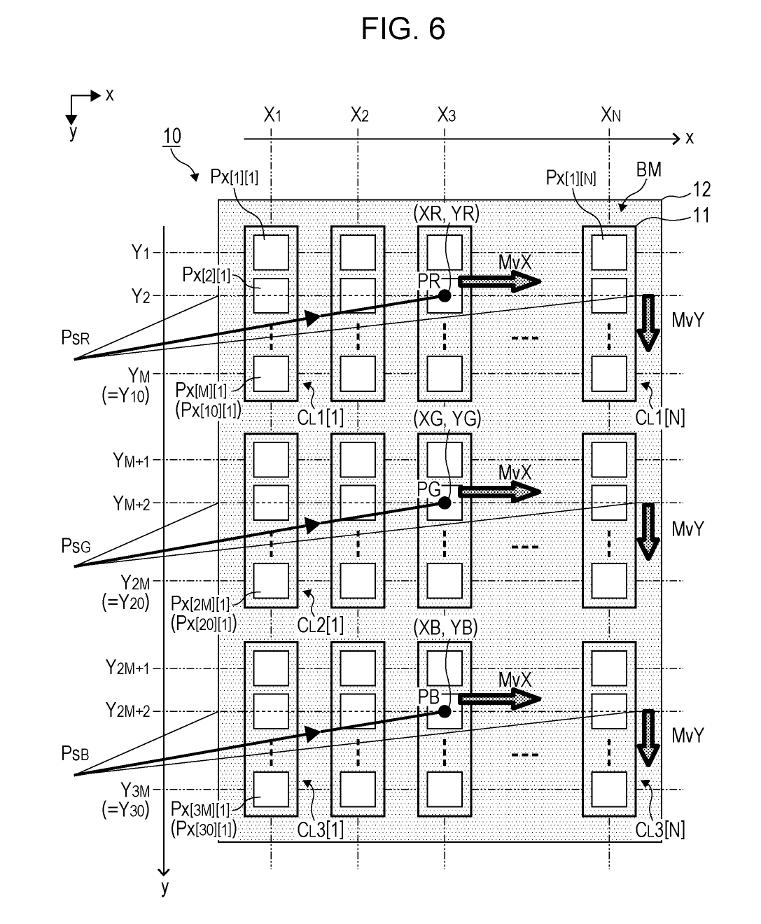

Below the display device according to the second embodiment (below, referred to as “display device 1A”) will be described with reference to FIGS. 6 to 9.

The display device 1A according to the second embodiment is similarly configured to the display device 1 according to the first embodiment shown in FIG. 1 except for being provided with a light source (below, referred to as “light source 30A”) that radiates a point-like light Ps instead of the light source 30 that radiates the linear light Ls.

Elements for which the actions and functions in each aspect given as an example below are the same as the first embodiment are given the same numbers referenced in the above description and a detailed description thereof will not be made, as appropriate (the same applies to the embodiments and modification examples described below).

FIG. 6 is an explanatory diagram for describing the irradiation position of the light Ps radiated by the light source 30A in the display portion 10.

As shown in FIG. 6, the light source 30A irradiates the display portion 10 with the three lights Ps. More specifically, the light source 30A irradiates the display portion 10 with the three lights Ps including the red light PsR (example of “first light”), the green light PsG (example of “second light”), and the blue light PsB (example of third light”).

Below, the point indicating the irradiation position of the red light PsR in the display portion 10 is referred to as point PR, the point indicating the irradiation position of the green light PsG is referred to as point PG, and the point indicating the irradiation position of the blue light PsB is referred to as the point PB. The position in the x axis direction of the point PR, point PR, and the point PB are respectively referred to as the irradiation positions XR, XG, and XB, and the positions in the y axis direction are respectively referred to as the irradiation positions YR, YG, and YB.

The light source 30 irradiates liquid crystal elements CL different from one another with each of the red light PsR, green light PsG, and blue light PsB. The light source 30 moves the irradiation positions of the three lights Ps in the x axis direction in each unit period H as indicated by the reference “MvX” in FIG. 6 and moves the irradiation positions of the three lights Ps in the y axis direction in each control period P as indicated by the reference “MvY” in FIG. 6.

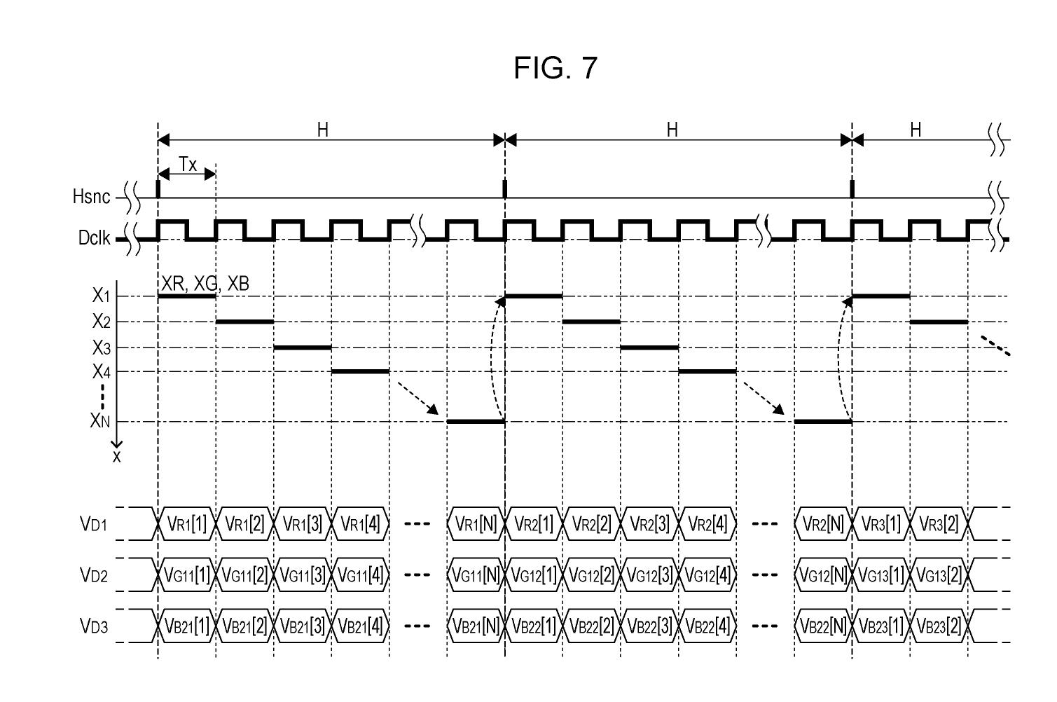

FIG. 7 is a timing chart showing the operation of the display device 1A.

As shown in the drawing, the dot clock signal Dclk is a signal that rises from low level to high level for each segment period Tx. The unit period H is divided into N segment periods Tx by the dot clock signal Dclk.

The light source 30A irradiates the irradiation position determined based on the vertical synchronization signal Vsnc, the horizontal synchronization signal Hsnc, and the dot clock signal Dclk with three lights Ps (PsR, PsG, and PsB).

More specifically, in each unit period H, the light source 30A radiates the three lights Ps so that the irradiation positions (XR, XG, XB) in the x axis direction of each of the three lights Ps moves in the (+x) direction by a distance corresponding to one pixel (example of a “predetermined direction”) for each segment period Tx, as shown in FIG. 7.

That is, the light source 30A radiates the three lights Ps so that the irradiation position of the three lights Ps becomes the position X₁ in the initial segment period Tx in each unit period H, is thereafter moved by one pixel in the (+x) direction for each segment period Tx, and becomes the position X₁₀ (X_{M}) in the final segment period Tx of the unit period H.

The light source 30A moves the irradiation positions (YR, YG, YB) in the y axis direction of each of the three lights Ls by one pixel in the (+y) direction for each unit period H in each control period P, similarly to the light source 30 in the first embodiment shown in FIG. 3 or 5.

That is, the light source 30A radiates one light Ps so that the irradiation position (example of “second irradiation position”) of the one light Ps in the nth segment period Tx of another unit period H that follows the one unit period H becomes (Xₙ, Yₙ₊₁) in a case where the irradiation position (example of “first irradiation position”) of the one light Ps in the nth segment period Tx of one unit period H is (Xₙ, Yₙ) in each control period P.

In the embodiment, the data line driving circuit 20 supplies the data signal VD that stipulates the gradation to be displayed by the pixel Px irradiated by the light Ps when the pixel Px is irradiated with the light Ps to the liquid crystal element CL corresponding to the pixel Px irradiated by the light Ps.

Specifically, in the embodiment, the data line driving circuit 20 supplies the data signal VRm[n] that stipulates the gradation when the pixel Px[m][n] displays red R in the segment period Tx in which the pixel Px[m][n] is irradiated with red light PsR to the liquid crystal element CLk[n] as the data signal VDk[n], supplies the data signal VGm[n] that stipulates the gradation when the pixel Px[m][n] displays green G in the segment period Tx in which the pixel Px[m][n] is irradiated with green light PsG to the liquid crystal element CLk[n] as the data signal VDk[n], and supplies the data signal VBm[n] that stipulates the gradation when the pixel Px[m][n] displays blue B in the segment period Tx in which the pixel Px[m][n] is irradiated with blue light PsB to the liquid crystal element CLk[n] as the data signal VDk[n], in a case where the pixel [m][n] is provided corresponding to the liquid crystal element CLk[n].

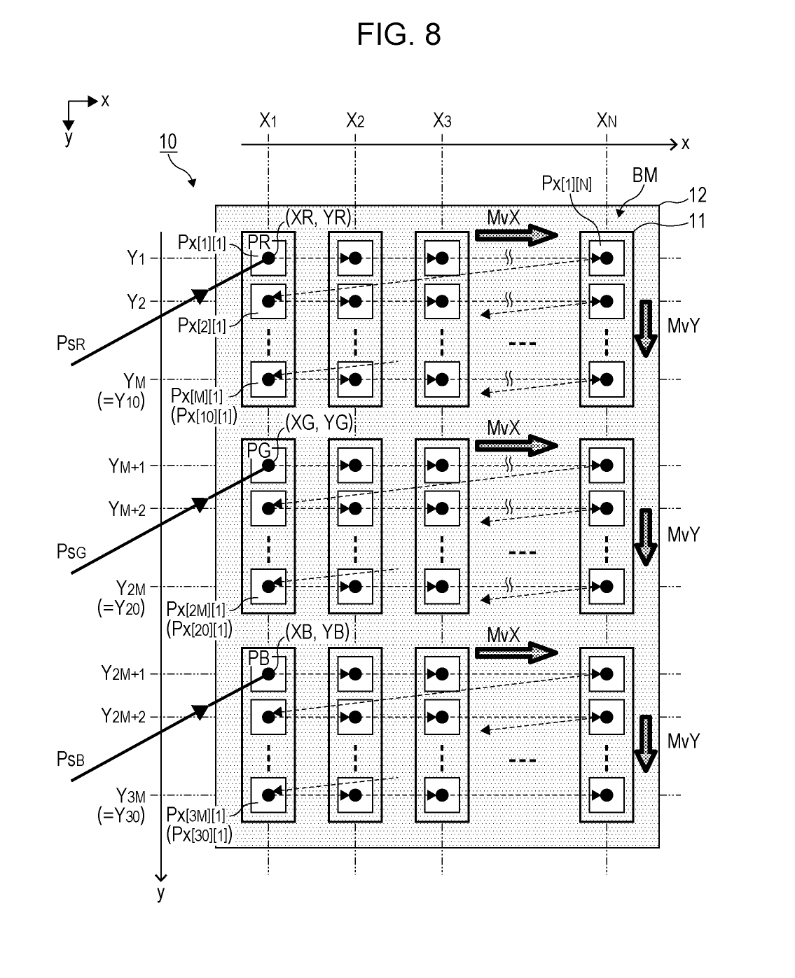

For example, in one unit period H, the data line driving circuit 20, as shown in FIGS. 7 and 8, supplies the data signals VR1[1] to VR1[N] that stipulate the gradation to be displayed by the pixels Px[1][1] to Px[1][N], respectively, to the liquid crystal elements CL1[1] to CL1[N], respectively, as data signals VD1[1] to VD1[N] in a case where the pixels Px[1][1] to Px[1][N] are irradiated by red light PsR, the pixels Px[11][1] to Px[11][N] are irradiated with green light PsG, and the pixels Px[21][1] to Px[21][N] are irradiated with blue light PsB. In this case, the data line driving circuit 20 supplies the data signals VG11[1] to VG11[N] that stipulate the gradation to be displayed by the pixels Px[11][1] to Px[11][N], respectively, to the liquid crystal element CL2[1] to CL2[N], respectively, as the data signal VD2[1] to VD2[N]. In this case, the data line driving circuit 20 supplies the data signals VG21[1] to VG21[N] that stipulate the gradation to be displayed by the pixels Px[21][1] to Px[21][N], respectively, to the liquid crystal element CL3[1] to CL3[N], respectively, as the data signal VD3[1] to VD3[N].

In another unit period H after the one unit period H, the data line driving circuit 20 supplies the data signals VR2[1] to VR2[N] that stipulate the gradation to be displayed by the pixels Px[2][1] to Px[2][N], respectively, to the liquid crystal elements CL1[1] to CL1[N], respectively, as data signals VD1[1] to VD1[N] because the pixels Px[2][1] to Px[2][N] are irradiated by red light PsR, the pixels Px[12][1] to Px[12][N] are irradiated with green light PsG, and the pixels Px[22][1] to Px[22][N] are irradiated with blue light PsB. In the other unit period H, the data line driving circuit 20 supplies the data signals VG12[1] to VG12[N] that stipulate the gradation to be displayed by the pixels Px[12][1] to Px[12][N], respectively, to the liquid crystal element CL2[1] to CL2[N], respectively, as the data signals VD2[1] to VD2[N]. In the other unit period H, the data line driving circuit 20 supplies the data signals VB22[1] to VB22[N] that stipulate the gradation to be displayed by the pixels Px[22][1] to Px[22][N], respectively, to the liquid crystal element CL3[1] to CL3[N], respectively, as the data signals VD3[1] to VD3[N].

As a result, as shown in FIG. 8, each of the pixels Px[1][n] to Px[10][n] corresponding to the liquid crystal element CL1[n] display red R, each of the pixels Px[11][n] to Px[20][n] corresponding to the liquid crystal element CL2[n] display green G, and each of the pixels Px[21][n] to Px[30][n] corresponding to the liquid crystal element CL3[n] display blue B in the control period P1.

Although not shown in the drawings, the pixels Px corresponding to the liquid crystal element CL1[n] display blue B, the pixels Px corresponding to the liquid crystal element CL2[n] display red R, and the pixels Px corresponding to the liquid crystal element CL3[n] display green G in the control period P2. The pixels Px corresponding to the liquid crystal element CL1[n] display green G, the pixels Px corresponding to the liquid crystal element CL2[n] display blue B, and the pixels Px corresponding to the liquid crystal element CL3[n] display red R in the control period P3.

In the embodiment, the data line driving circuit 20 supplied the data signal VDk[n] that stipulates the gradation to be displayed by the pixel Px[m][n] to the liquid crystal element CLk[n] corresponding to the pixels Px[m][n] in the segment period Tx in which the pixel Px[m][n] is irradiated with the light Ps; however, the invention is not limited to such an aspect.

For example, in a case where the pixels Px[m][1] to Px[m][N] are irradiated in order with the light Ps for each segment period Tx in the unit period H, the data line driving circuit 20 may supply the data signals VDk[1] to VDk[N] to the liquid crystal elements CLk[1] to CLk[N] corresponding to the pixels Px[m][1] to Px[m][N] at the same time at the timing at which the unit period H is started.

In the embodiment, the irradiation position of the light Ps is moved by one pixel in the x axis direction for each segment period Tx by the light source 30A moving the irradiation position of the light Ps by one pixel in the x axis direction when the segment period Tx finishes (or when starting) without varying the irradiation position in the one segment period Tx; however, the invention is not limited to such an aspect.

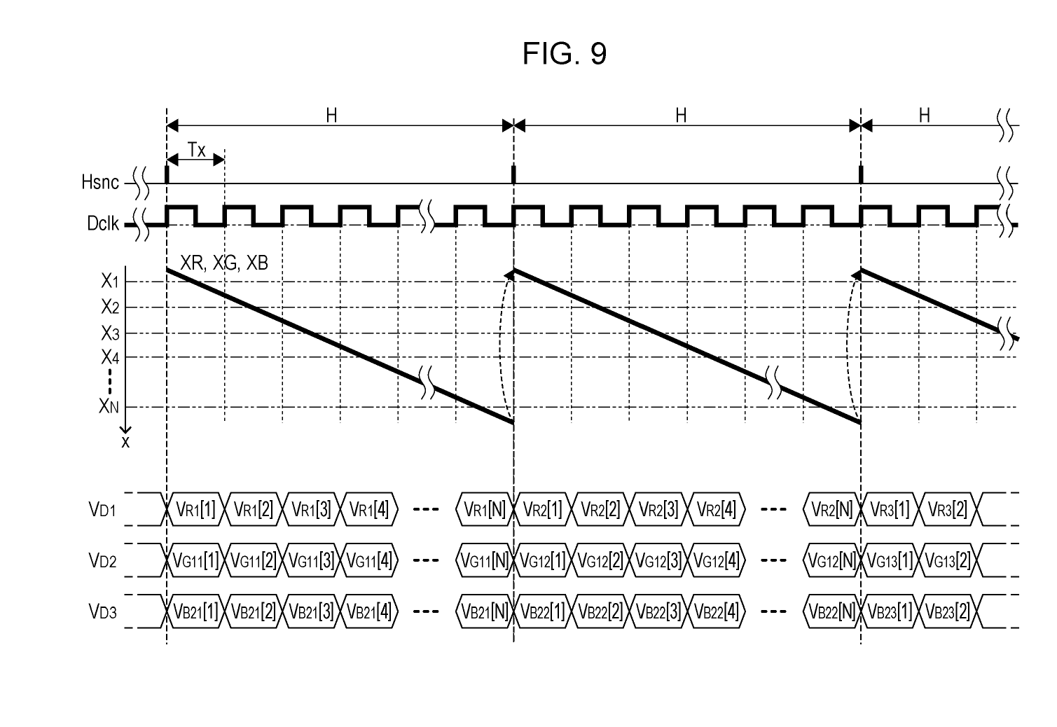

For example, the light source 30A may continuously (for example, at a constant speed) move the irradiation position of light Ps, as shown in FIG. 9.

In short, the light source 30 is usable as long as the light source radiates light Ps so that only the pixel Px that contributes to display is irradiated with the light Ps in each segment period Tx, and the pixels Px that do not contribute to display in each segment period Tx are not irradiated with the light Ps.

That is, the light source 30A is usable as long as the light source radiates the three lights Ps so that the above-described conditions (1) and (2) are satisfied.

### <C. Third Embodiment>

The display device 1 according to the first embodiment is provided with a display portion 10 in which “3×N” liquid crystal elements CL in three vertical columns×N horizontal rows are provided, and is provided with a light source 30 that radiates the three lights Ls at the same time.

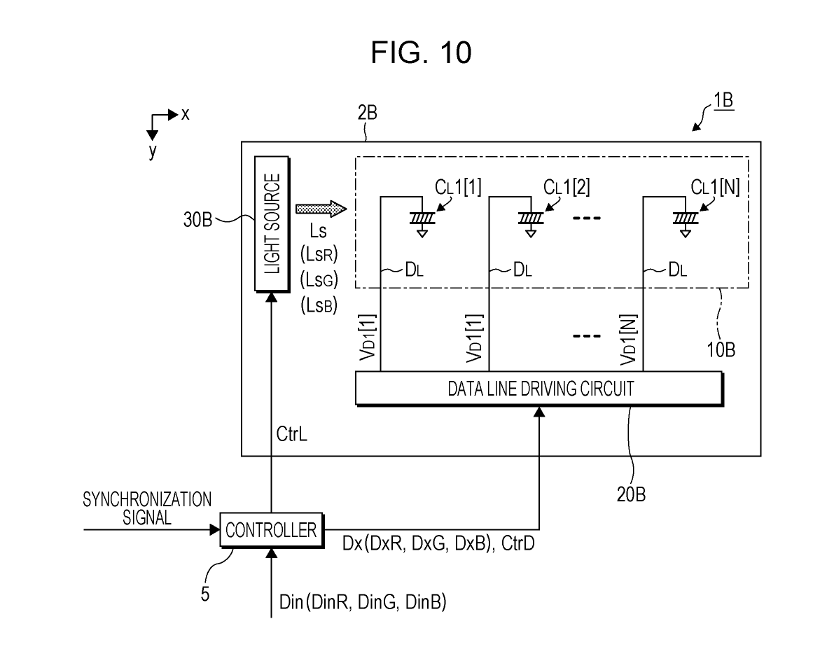

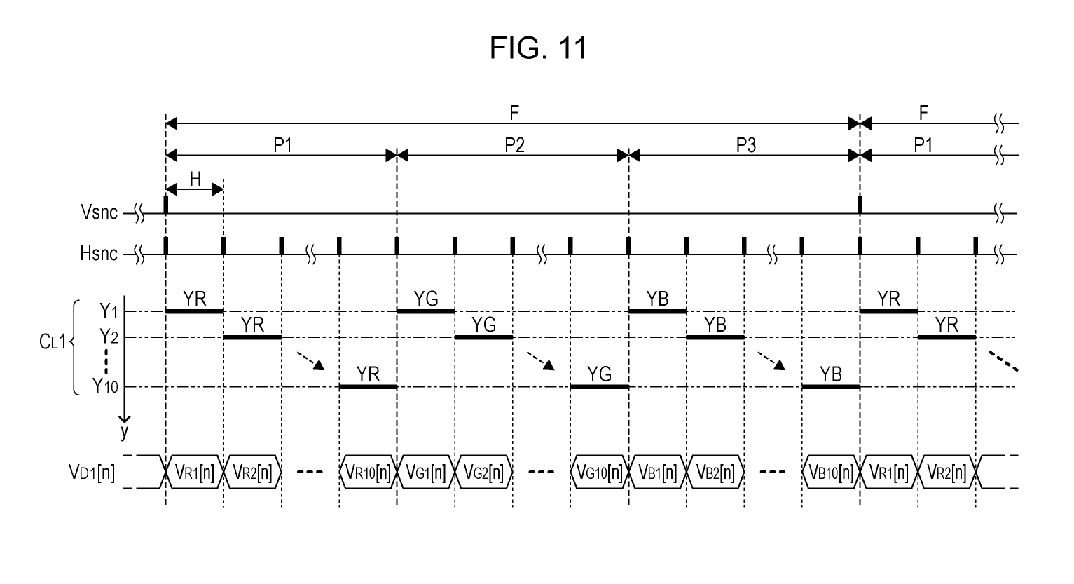

In contrast, the display device according to the third embodiment differs from the display device 1 according to the first embodiment on the point of being provided with a display portion in which N liquid crystal elements CL in one vertical columns x N horizontal rows are provided, and being provided with a light source that radiates the one light Ls at the same time. Below, the display device according to the third embodiment will be described with reference to FIGS. 10 and 11.

FIG. 10 is a block diagram of a display device 1B (example of “electro-optical device”) according to the third embodiment of the invention. The display device 1B shown in FIG. 10 is configured similarly to the display device 1 according to the first embodiment shown in FIG. 1 except for being provided with a display panel 2B instead of the display panel 2.

The display panel 2B is provided with a display portion 10B, a light source 30B, a data line driving circuit 20B, and a data line DL.

As shown in FIG. 10, N liquid crystal elements CL1[n] are provided in one vertical column×N horizontal rows in the display portion 10B. That is, the display portion 10B is configured similarly to the display portion 10 according to the first embodiment other than being provided with only the liquid crystal element CL1[n] from among the liquid crystal elements CL1[n], CL2[n], and CL3[n] provided in the display portion 10 shown in FIG. 2, and not provided with the liquid crystal element CL2[n] and liquid crystal element CL3[n].

As shown in FIG. 10, the N data lines DL1[n] are provided corresponding to the N liquid crystal element CL1[n] in the display panel 2B.

The light source 30B irradiates the display portion 10B with one light Ls at the same time. Specifically, the light source 30B irradiates the display portion 10B with red light LsR in the control period P1, with the green light LsG in the control period P2, and with the blue light LsB in the control period P3.

The data line driving circuit 20B supplies the data signal VD1[n] to the liquid crystal element CL1[n] via the data line DL1[n].

FIG. 11 is a timing chart showing an operation of the display device 1B.

As shown in FIG. 11, the light source 30B irradiates the liquid crystal element CL1[n] with the red light LsR in the control period P1, and moves the irradiation position YR of the red light LsR by one pixel in the (+y) direction for each unit period H.

The light source 30B irradiates the liquid crystal element CL1[n] with the green light LsG in the control period P2, and moves the irradiation position YG of the green light LsG by one pixel in the (+y) direction for each unit period H.

The light source 30B irradiates the liquid crystal element CL1[n] with the blue light LsB in the control period P3, and moves the irradiation position YB of the blue light LsB by one pixel in the (+y) direction for each unit period H.

The data line driving circuit 20B supplies the data signal VD that stipulates the gradation to be displayed by the pixel Px irradiated by the light Ls when the pixel Px is irradiated with the light Ls to the liquid crystal element CL corresponding to the pixel Px irradiated by the light Ls.

Specifically, the data line driving circuit 20B supplies the data signal VRm[n] that stipulates the gradation when the pixel [m][n] displays red R to the liquid crystal element CL1[n] as the data signal VD1[n] in a unit period H in which the pixel Px[m][n] is irradiated with the red light LsR in the control period P1 (in the embodiment, m is a natural number that satisfies 1≦m≦M).

The data line driving circuit 20B supplies the data signal VGm[n] that stipulates the gradation when the pixel [m][n] displays green G to the liquid crystal element CL1[n] as the data signal VD1[n] in a unit period H in which the pixel Px[m][n] is irradiated with the green light LsG in the control period P2.

The data line driving circuit 20B supplies the data signal VBm[n] that stipulates the gradation when the pixel [m][n] displays blue B to the liquid crystal element CL1[n] as the data signal VD1[n] in a unit period H in which the pixel Px[m][n] is irradiated with the blue light LsB in the control period P3.

In this way, each pixel Px provided in the display portion 10B is irradiated by the three lights Ls including red light LsR, green light LsG, and blue light LsB in each display period F.

Therefore, each pixel Px of the display device 1 according to the embodiment displays the three colors of red R, green G, and blue B in each display period F.

As described above, because the display portion 10B according to the embodiment includes one liquid crystal element CL in each row, it is possible to simplify the structure of the display portion 10B compared to a case of including a plurality of liquid crystal elements CL in each row. Therefore, in the embodiment, it is possible to reduce the manufacturing costs of the display device 1B to be low, compared to a case where a plurality of liquid crystal elements CL are included in each row.

In the embodiment, although the light source 30B radiates a “linear” light Ls, the invention is not limited to such an aspect. The light source 30B may radiate a “point-like” light Ps. In this case, similarly to the light source 30A in the second embodiment, as long as the irradiation position of the light Ps is moved by one pixel in the x axis direction for each segment period Tx, the light source is usable (refer to FIG. 7).

The light source 30B, as shown in FIG. 5 (or FIG. 9), may continuously (for example, at a constant speed) move the irradiation position of light Ls (or light Ps).

### <D. Fourth Embodiment>

The display device 1 according to the first embodiment causes the display portion 10 to display three colors through the light source 30 irradiating the display portion 10 with the three colors of light Ls including red light LsR, green light LsG, and blue light LsB.

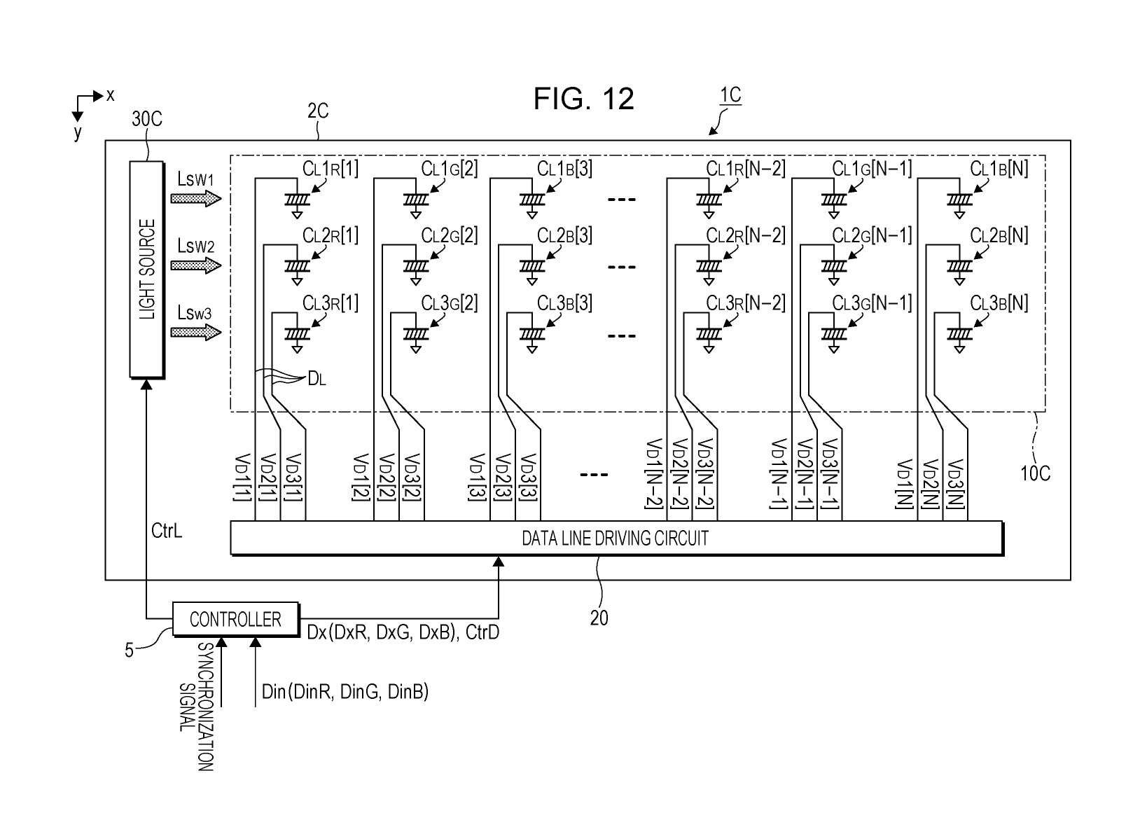

In contrast, the display device according to the fourth embodiment differs from the display device 1 according to the first embodiment on the point of the display portion displaying the three colors through the display portion including a color filter CF. Below, the display device according to the fourth embodiment will be described with reference to FIGS. 12 to 14.

FIG. 12 is a block diagram of a display device 1C (example of “electro-optical device”) according to the fourth embodiment of the invention. The display device 1C shown in FIG. 12 is configured similarly to the display device 1 according to the first embodiment shown in FIG. 1 except for the point of being provided with a display panel 2C instead of the display panel 2.

The display panel 2C is provided with a display portion 10C, a light source 30C, a data line driving circuit 20, and a data line DL, and a color filter CF (not shown). That is, the display panel 2C is configured similarly to the display panel 2 shown in FIG. 1 except for the points of being provided with a display portion 10C instead of the display portion 10, provided with the light source 30C instead of the light source 30, and provided with a color filter CF.

The color filter CF includes a color filter CFR (example of a “first color filter”) through which red R light passes, a color filter CFG (example of a “second color filter”) through which green G light passes, and a color filter CFB (example of a “third color filter”) through which blue B light passes.

As shown in FIG. 12, the display portion 10C is configured similarly to the display portion 10 shown in FIG. 2 except for the point of being provided with a color filter CF (CF_{R}, CF_{G}, CF_{B}).

In the embodiment, the color filter CF_{R} is provided corresponding to the n₁th row of liquid crystal elements CL, the color filter CF_{G} is provided corresponding to the n₂th row of liquid crystal elements CL, and the color filter CF_{R} is provided corresponding to the n₃th row of liquid crystal elements CL. n₁ is n₁≡1(mod3), and is a natural number that satisfies 1≦n₁≦N (that is, n₁=1, 4, 7, . . . ), n₂ is n₂≡2(mod3), and is a natural number that satisfies 2≦n₂≦N (that is, n₂=2, 5, 8, . . . ), and n₃ is n₃≡0(mod3), and is a natural number that satisfies 3≦n₁≦N (that is, n₃=3, 6, 9, . . . ).

Below, the liquid crystal element CLk[n₁] of the n₁th row provided corresponding to the color filter CFR is referred to as the liquid crystal elements CLk_{R}[n₁], the liquid crystal element CLk[n₂] of the n₂th row provided corresponding to the color filter CFG is referred to as the liquid crystal element CLk_{G}[n₂], and the liquid crystal element CLk[n₃] of the n₃th row of provided corresponding to the color filter CFB is referred to as the liquid crystal element CLk_{B}[n₃].

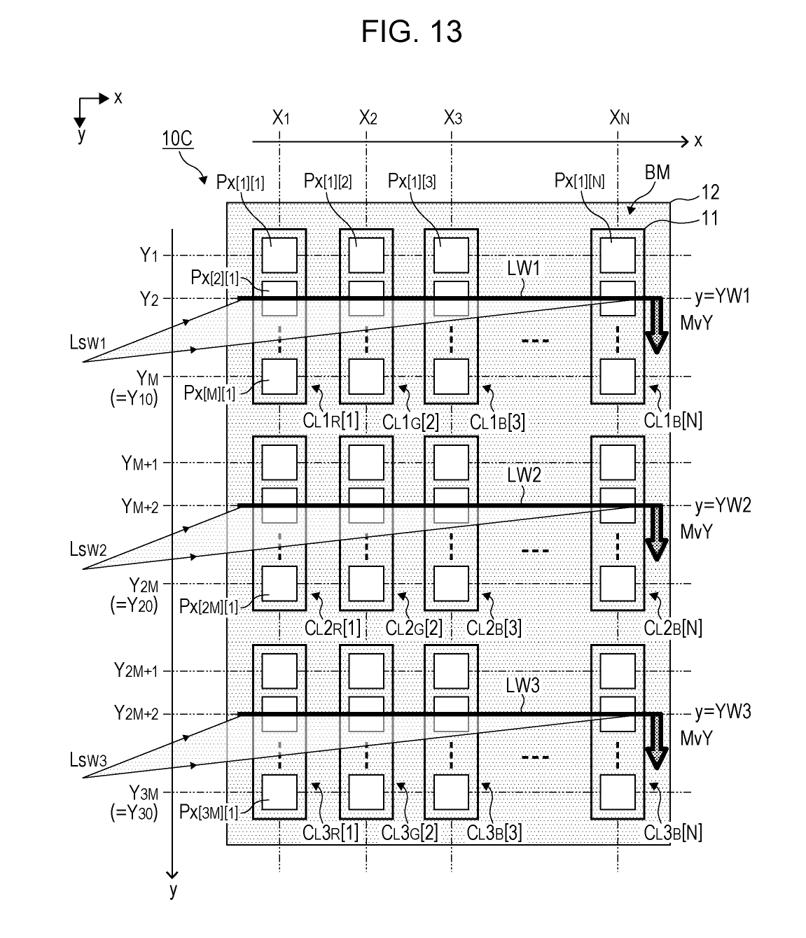

FIG. 13 is an explanatory diagram for describing the irradiation position of the light Ls irradiated by the light source 30C in the display portion 10.

As shown in FIG. 13, the light source 30C irradiates the display portion 10C with the three lights Ls at the same time. In the embodiment, the three lights Ls radiated by the light source 30C are all white W (example of “predetermined color”) light. More specifically, the light source 30C irradiates the display portion 10 with the three white lights LsW including the white light LsW₁, the white light LsW₂, and the white light LsW₃ at the same time.

That is, the light source 30C is configured similarly to the light source 30 shown in FIG. 1 except for the point of radiating the white light LsW₁, white light LsW₂, and white light LsW₃ instead of the red light LsR, green light LsG, and the blue light LsB.

Below, the line segment indicating the irradiation position of the white light LsW₁ in the display portion 10C is referred to as line segment LW₁, the line segment indicating the irradiation position of the white light LsW₂ is referred to as line segment LW₂, and the line segment indicating the irradiation position of the white light LSW₃ is referred to as the line segment LW₃. The positions in the y axis direction of the line segments LW₁, LW₂, and LW₃ are respectively referred to as the irradiation positions YW₁, YW₂, and YW₃. The line segments LW₁, LW₂, and LW₃ are at least line segments including the range X₁≦x≦X_{N} in the x axis direction, similarly to the light segment LR and the like.

The light source 30C irradiates liquid crystal elements CL that are different from one another with each of the three white lights LsW, and moves the irradiation position of the three white light LsW in the y axis direction in each control period P as indicated by the reference symbol “MvY” in FIG. 13.

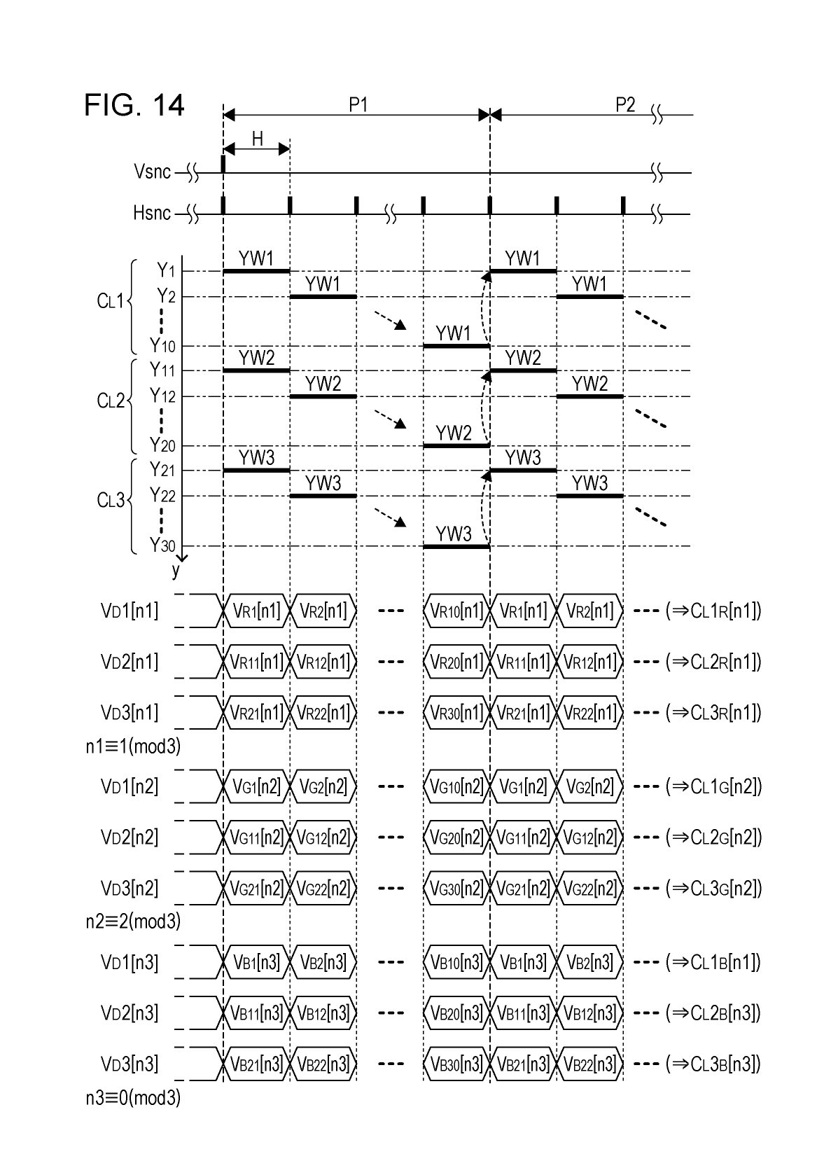

FIG. 14 is a timing chart showing the operation of the display device 1C.

As shown in FIG. 14, the light source 30C radiates the white light LsW₁ so that the irradiation position YW₁ of the white light LsW₁ becomes the position Y₁ (Y₁ in FIG. 14) corresponding to the pixel Px[1][n] provided on the end portion in the (−y) direction of the liquid crystal element CL1[n] at a timing at which each control period P is started, radiates the white light LsW₂ so that the irradiation position YW₂ of the white light LsW₂ becomes the position Y_{M+1} (Y₁₁ in FIG. 14) corresponding to the pixel Px[M+1][n] provided on the end portion in the (−y) direction of the liquid crystal element CL2[n], and radiates the white light LSW₃ so that the irradiation position YW₃ of the white light LsW₃ becomes the position 2Y_{M+1} (Y₂₁ in FIG. 14) corresponding to the pixel Px[2M+1][n] provided on the end portion in the (−y) direction of the liquid crystal element CL3[n].

The light source 30C radiates the three white lights LsW so that the respective irradiation positions (YW₁, YW₂, YW₃) of the three lights in the y axis direction move by one pixel in the (+y) direction for each unit period H in each control period P.

In so doing, the light source 30C irradiates the liquid crystal elements CL that are different from one another with the three white lights LsW in each unit period H.

The irradiation positions of the three white lights LsW shown in FIG. 14 are merely examples, and the light source 30C may radiate the three white lights LsW so that the irradiation positions (YW₁, YW₂, YW₃) of each of the three white lights LsW become the same as the irradiation positions (YR, YG, YB) of the three lights Ls (LsR, LsG, LsB) shown in FIG. 3.

The data line driving circuit 20 supplies the data signal VD that stipulates the gradation to be displayed by the pixel Px irradiated by the light Ls when the pixel Px is irradiated with the light Ls to the liquid crystal element CL corresponding to the pixel Px irradiated by the light Ls.

In the embodiment, the pixel Px[m][n₁] provided corresponding to the n₁th row of liquid crystal elements CL displays red R, the pixel Px[m][n₂] provided corresponding to the n₂th row of liquid crystal elements CL displays green G, and the pixel Px[m][n₃] provided corresponding to the n₃th row of liquid crystal elements CL displays blue B.

Therefore, the data line driving circuit 20 supplies the data signal VRm[n₁] that stipulates the gradation to be displayed by the pixel Px[m][n₁] to the liquid crystal element CLk[n₁] as the data signal VDk[n₁], in the unit period H in which the pixel [m][n₁] is irradiated with white light LsW in a case where the pixel Px[m][n₁] able to display red R is provided corresponding to the liquid crystal element CLk[n₁].

The data line driving circuit 20 supplies the data signal VGm[n₂] that stipulates the gradation to be displayed by the pixel Px[m][n₂] to the liquid crystal element CLk[n₂] as the data signal VDk[n₂], in the unit period H in which the pixel [m][n₂] is irradiated with white light LsW in a case where the pixel Px[m][n₂] able to display green G is provided corresponding to the liquid crystal element CLk[n₂].

The data line driving circuit 20 supplies the data signal VBm[n₃] that stipulates the gradation to be displayed by the pixel Px[m][n₃] to the liquid crystal element CLk[n₃] as the data signal VDk[n₃], in the unit period H in which the pixel [m][n₃] is irradiated with white light LsW in a case where the pixel Px[m][n₃] able to display blue B is provided corresponding to the liquid crystal element CLk[n₃].

As described above, the display portion 10C according to the embodiment is provided with a pixel Px[m][n₁] that is provided corresponding to the color filter CFR and that displays red R, a pixel Px[m][n₂] that is provided corresponding to the color filter CF_{G} and that displays green G, and a pixel Px[m][n₃] that is provided corresponding to the color filter CF_{B} and that displays blue B. That is, the display device 1C according to the embodiment is able to display the three colors including red R, green G, and blue B even in a case where the light source 30C radiates only the white light LsW. Therefore, it is possible to simplify the structure of the light source 30C and possible to suppress the manufacturing costs of the display device 1C to be low, compared to a case of radiating the three colors of light LsR, LsG, and LsG.

In the embodiment, although the light source 30C radiates a “linear” light Ls, the invention is not limited to such an aspect. The light source 30C may radiate a “point-like” light Ps as in the light source 30A according to the second embodiment. In this case, it is preferable that the light Ps radiated by the light source 30c is white light. In this case, similarly to the light source 30A in the second embodiment, as long as the irradiation position of the light Ps is moved by one pixel in the x axis direction for each segment period Tx, the light source is usable (refer to FIG. 7).

The light source 30C, as shown in FIG. 5 (or FIG. 9), may continuously (for example, at a constant speed) move the irradiation position of light Ls (or light Ps).

In the embodiment, three vertical columns of liquid crystal elements CL are provided in the display portion 10C; however, the invention is not limited to such an aspect. The display portion 10C is usable as long as the display portion is provided with one vertical column of liquid crystal elements CL as in the display portion 10B according to the third embodiment. In this case, the light source 30C may radiate one white light LsW at the same time.

### <E. Modification Example>

Each of the above aspects may be modified in various ways. Specific aspects of the modifications are given below as examples. Two or more aspects arbitrarily selected from the following examples may be combined, as appropriate within a range not contradicting each other.

### <Modification Example 1>

In the embodiment described above, although the display portions (10, 10B or 10C) are provided with three or one vertical columns of liquid crystal element CL, the invention is not limited to such an aspect, and a predetermined number K (K is a natural number that satisfies 1≦K) of liquid crystal elements CL may be included in each column. That is, the display portion may be provided with a block BL[n] formed from K vertical columns of liquid crystal elements CL of liquid crystal elements CL1[n] to CLK[n] in each row.

In this case, the light source (30, 30A, 30B, or 30C) is usable as long as the light source irradiates the display portion with the light Ls or light Ps so that the above-described conditions (1) and (2) are satisfied.

For example, the light source may radiate a predetermined number K of lights Ls or lights Ps at the same time. In this case, the light source is usable as long as the light source radiates a predetermined number K of lights Ls or lights Ps with a one-to-one correspondence to each column of liquid crystal elements CL of the K vertical columns in each unit period H.

The light source may radiate one light Ls or light Ps at the same time. In this case, it is preferable that the controller 5 generates the driving control signal CtrD and the light source control signal CtrL so as to divide the display period F into a predetermined number K of control periods P, and the light source irradiates all of the pixels Px corresponding to all of the liquid crystal elements CL with one light Ls or light Ps in each of the predetermined number K of control periods P.

### <Modification Example 2>

In the above-described embodiments and the modification example, although the display device (1, 1A, 1B, or 1C) displays the three colors of red R, green G and blue B, the invention is not limited to such an aspect, and the display device is usable as long as the display device is able to display one or two or more colors.

For example, in a case where the display device is able to display a predetermined number K of colors, the light source may radiate a predetermined number K of lights Ls or lights Ps respectively corresponding to a predetermined number K of colors, or the display portion may be provided with a predetermined number K of types of color filter CF corresponding respectively to the predetermined number K of colors.

### <Modification Example 3>

In the embodiment and the modification examples described above, although the display portions (10, 10B or 10C) are provided with the liquid crystal element CL, the invention is not limited to such an aspect, and as long as an electro-optical element with a variable transmissivity is included, the display portion is usable.

The display portion may include, for example, an electro-optical element able to adjust the light amount of light radiated from the light source, as a shutter.

### <Modification Example 4>

In the above-described embodiments and modification examples, the y axis direction is set as the first direction and the liquid crystal element CL is provided so as to extend in the y axis direction (in a shape such that the y axis direction is vertically long); however, the invention is not limited thereto, and the x axis direction may be set as the first direction and the liquid crystal element CL may be provided so as to extend in the x axis direction (shape such that the x axis direction is vertically long). In this case, the y axis direction may be set as the second direction and the light Ls may be made linear light having a spread in the y axis direction, and the irradiation positions of the light Ls or light Ps may be moved in the x axis direction in each control period P.

The first direction may be an arbitrary direction different to the x axis direction and the y axis direction. In this case, the direction in which the liquid crystal element CL extends and the direction in which the light Ls or light Ps moves in each control period P are a first direction different from the x axis direction and the y axis direction. In this case the second direction that is the direction in which the light Ls has a spread may be any direction as long as it is different from the first direction.

### <Modification Example 5>

In the above-described embodiment and modification examples, although the display portion (10, 10B, or 10C) is provided with a black matrix BM, the invention is not limited to such an aspect, and the display portion may be not provided with black matrix BM. Even in this case, it is possible for the pixels Px to be defined by the irradiation position of light in each unit period H.

More specifically, in a case where the irradiation positions of the light Ls or light Ps are the position Xₙ and position Yₘ in one unit period H, the part determined by the position Xₙ and position Yₘ of the display portion 10 is a part that contributes to display in the one unit period H, and the part is defined as one pixel Px. Therefore, even in a case where the black matrix BM is not provided, the observer of the display portion 10 observes that the display portion is provided with a plurality of pixels Px.

### <F. Application Example>

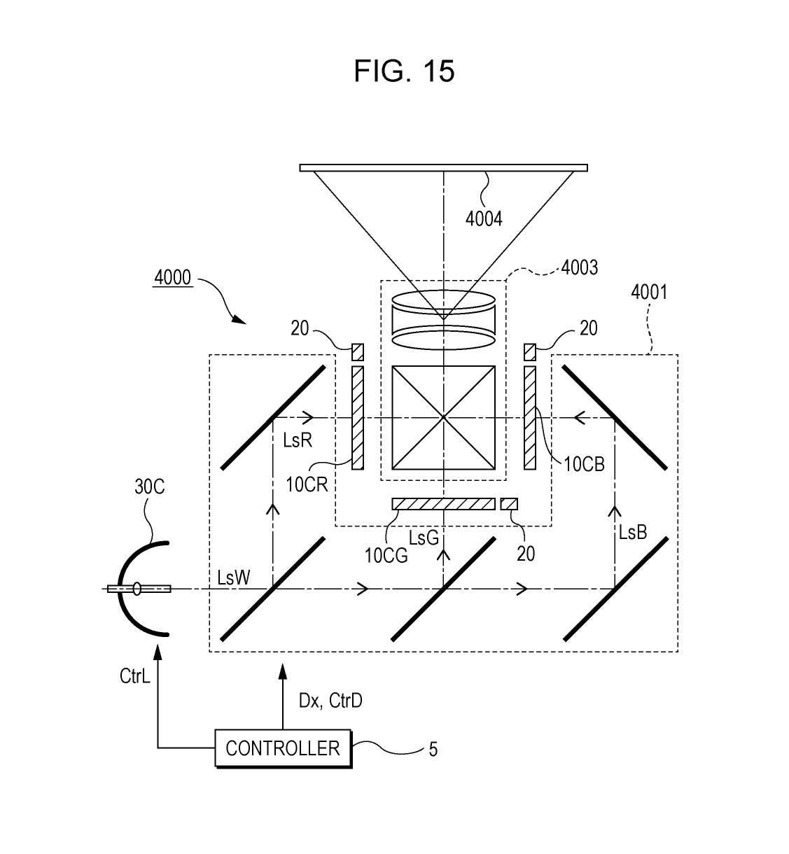

The display device given as an example in each of the above forms is able to be used in various electronic apparatuses. FIGS. 15 to 17 show an example of specific forms of an electronic apparatus in which the display device is employed.

FIG. 15 is a schematic diagram of a projection-type display device (3-plate type projector) 4000 in which the display device is employed. The projection-type display device 4000 is configured to include the display device. More specifically, the projection-type display device 4000 is configured to include three display portions 10 (10R, 10G, 10B) corresponding to differing display colors (red, green, blue), the light source 30C that radiates the white light LsW, the data line driving circuit 20, and the controller 5.

The illumination optical system 4001 supplies the red light LsR having a component of red R to the display portion 10R, supplies the green light LsG having a component of green G to the display portion 10G, and supplies the red light LsR having a component of red R to the display portion 10R of the white light LsW emitted from the light source 30C. Each display portion 10 functions as an optical modulator (light valve) that modulates the light Ls supplied from the light source 30C according to the displayed image. A projection optical system 4003 projects the light on a projection surface 4004 by synthesizing the light emitted from the each display portion 10. The observer views the image projected on the projection surface 4004.

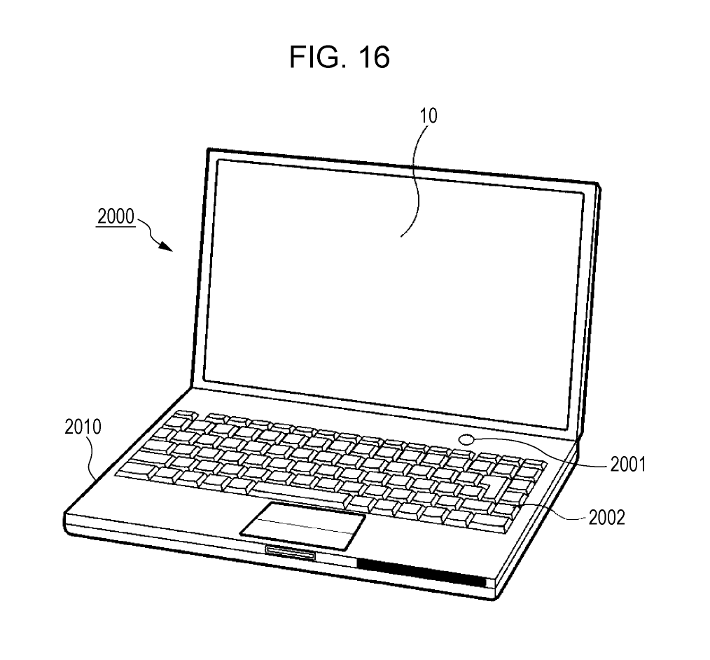

FIG. 16 is a perspective view illustrating a portable personal computer in which the display device 1 is employed. The personal computer 2000 includes a display device 1 that displays various images, and a main body portion 2010 provided with a power supply switch 2001 and a keyboard 2002.

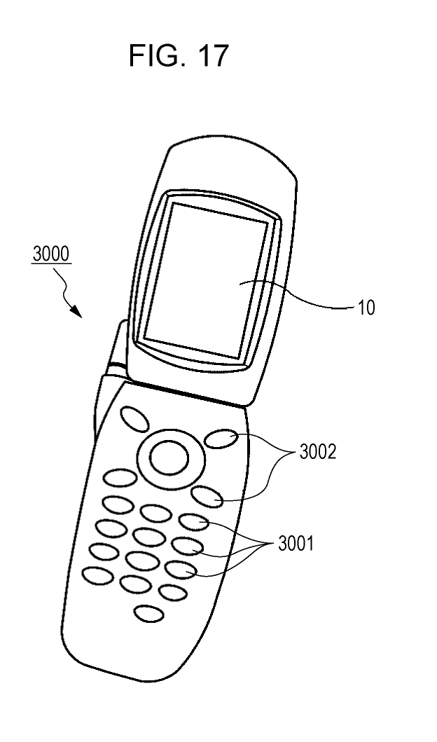

FIG. 17 is a perspective view illustrating a mobile phone in which the display device 1 is employed. The mobile phone 3000 includes a plurality of operation buttons 3001 and scroll buttons 3002, and the display device 1 that displays various images. The screen displayed on the display device 1 is scrolled by operating the scroll buttons 3002.

Examples of electronic apparatuses to which the display device according to the invention is applied include a mobile information terminal (PDA: personal digital assistants), a digital still camera, a television, a video camera, a car navigation device, a vehicle mounted display device (instrument panel), an electronic notebook, electronic paper, a calculator, a word processor, a work station, a video phone, a POS terminal, a printer, a scanner, a copier, a video player, and an apparatus provided with a touch panel, in addition to the devices given as examples in FIGS. 15 to 17.

### REFERENCE SIGNS LIST

The entire disclosure of Japanese Patent Application No. 2013-084616, filed Apr. 15, 2013 is expressly incorporated by reference herein.

1. An electro-optical device comprising:
K (K is an integer of 1 or more and three or less) electro-optical elements extending in a first direction;
K data lines connected to the K electro-optical elements;
a supply portion that supplies gradation signals to the K electro-optical elements via the K data lines; and
a light source that irradiates the K electro-optical elements with L (L is an integer of 1 or more and 3 or less) lights,
wherein the light source moves irradiation positions of the L lights in the first direction, and
the supply portion supplies gradation signals corresponding to the gradation to be displayed at the irradiation positions of the L lights in the K electro-optical elements to the K electro-optical elements when the K electro-optical elements are irradiated by the light source.

2. The electro-optical device according to claim 1,
wherein, in a case where K is 1, and
L is 3, the light source irradiates a first electro-optical element with a first light, and moves an irradiation position of the first light in the first direction in a first period,
irradiates the first electro-optical element with a second light different from the first light, and moves an irradiation position of the second light in the first direction in a second period after the first period, and
irradiates the first electro-optical element with a third light different from the first and second lights, and moves an irradiation position of the third light in the first direction a third period after the second period.

3. The electro-optical device according to claim 1,
wherein, in a case where K is 3 and L is 3, the light source irradiates the first electro-optical element with the first light, irradiates the second electro-optical element with the second light different from the first light, irradiates the second electro-optical element with a third light different from the first and second lights, and moves the irradiation positions of the first, second, and third lights in the first direction in the first period,
irradiates the second electro-optical element with the first light, irradiates the third electro-optical element with the second light, and irradiates the first electro-optical element with the third light, and moves the irradiation positions of the first, second and third lights in the first direction in the second period after the first period, and
irradiates the third electro-optical element with the first light, irradiates the first electro-optical element with the second light, and irradiates the second electro-optical element with the third light, and moves the irradiation positions of the first, second, and third lights in the first direction in a third period after the second period.

4. The electro-optical device according to claim 1,
wherein the light radiated by the light source is linear light having a spread in the second direction that crosses the first direction.

5. The electro-optical device according to claim 1,
wherein the light source moves the irradiation positions of the L lights a plurality of times in the second direction that crosses the first direction while the irradiation positions of the L lights are moved once in the first direction.

6. The electro-optical device according to claim 1,
wherein K electro-optical elements are arranged line up in one row in the first direction, and
the K electro-optical elements lined up in one row are arranged in a plurality of rows in the second direction that crosses the first direction.

7. The electro-optical device according to claim 1 further comprising:
a first color filter having a first color, a second color filter having a second color different from the first color, and a third color filter having a third color different from the first and second colors,
wherein the K electro-optical elements includes a first electro-optical element provided corresponding to the first color filter, a second electro-optical element provided corresponding to the second color filter, and a third electro-optical element provided corresponding to the third color filter.

8. An electronic apparatus comprising:
the electro-optical device according to any one of claims 1 to 7.

9.-13. (canceled)
